(19) United States
(12) Patent Application Publication
(10) Pub. No.: US 2012/0282453 A1
(43) Pub. Date: Nov. 8, 2012

(54) CARBON NANOTUBE COMPOSITES AND METHODS AND APPARATUS FOR FABRICATING SAME

(75) Inventors: XIN WANG, RALEIGH, NC (US); YUNTIAN T. ZHU, Cary, NC (US); PHILIP D. BRADFORD, RALEIGH, NC (US); WEI LIU, ANHOUI PROVINCE (CN)

(73) Assignee: NORTH CAROLINA STATE UNIVERSITY, RALEIGH, NC (US)

(21) Appl. No.: 13/464,119

(22) Filed: May 4, 2012

Related U.S. Application Data
(60) Provisional application No. 61/482,691, filed on May 5, 2011.

(51) Int. Cl. B32B 27/04; B05C 5/00; B05D 1/02; B82Y 40/00

(52) U.S. Cl. 428/299.1; 427/427; 118/320; 977/842; 977/742

(57) ABSTRACT

In a method for fabricating a carbon nanotube (CNT) composite, an array of CNTs is provided. A CNT ribbon is pulled from the array and wound on a rotating mandrel. A polymer solution is applied to the ribbon to form a CNT composite laminate. The CNTs in the ribbon may be substantially aligned in a single direction. The ribbon may be attached to the mandrel such that the ribbon may be wound on the mandrel as the mandrel rotates. A CNT composite is provided that may include a polymer integrated with long, substantially straight CNTs that are highly aligned in a single direction. An apparatus for fabricating a CNT composite is provided that may include a rotatable mandrel and a spray gun. The spray gun may be configured for spraying a polymer solution on the CNT ribbon as the CNT ribbon is taken up on the rotating mandrel.

### RELATED APPLICATIONS

This application claims the benefit of U.S. Provisional Patent Application Ser. No. 61/482,691, filed May 5, 2011, titled “CARBON NANOTUBE COMPOSITES AND METHODS AND APPARATUS FOR FABRICATING SAME”, the content of which is incorporated by reference herein in its entirety.

### TECHNICAL FIELD

The present invention relates generally to carbon nanotube composites and methods for fabricating carbon nanotube composites. More particularly, the present invention relates to a spray winding process for preparing carbon nanotube composites with highly desirable structural characteristics and mechanical properties.

### BACKGROUND

Carbon nanotubes (“CNTs”) may be considered as “nano-fibers” that are an order of magnitude stronger than the strongest engineering fibers (such as carbon fibers and glass fibers), which makes them an ideal reinforcement for advanced multifunctional composites [1-2]. CNTs have highly desirable mechanical, thermal and electrical properties. However, after two decades of extensive research it remains a great challenge to produce CNT-polymer composites with superior properties and in a manner conducive to large-scale production [3-5]. To fully utilize the reinforcing potential of CNTs, it is important to use long CNTs in high volume fractions with a high degree of alignment while uniformly surrounding individual CNTs with the polymer matrix (thus increasing load transfer efficiency, for example) [6-8]. This structure is extremely difficult to achieve in conventional approaches, such as dispersion of CNTs in a polymer matrix by mixing. Long CNTs tend to agglomerate, making them difficult to disperse in any solvent or matrix. In addition, the entanglement of long CNTs makes CNT aligning very challenging, especially at high volume fractions. CNT composites fabricated by dispersion methods usually exhibit low tensile strength (e.g., less than 500 MPa) and low CNT mass fractions (e.g., less than 10 wt %). These issues are more severe when thermoplastic polymers are used as the matrix because the large molecular chains have to penetrate nano-scale interstices between bundled and tangled CNTs. Thermoplastic matrices are desired in composite applications requiring high toughness and/or high strain-to-failure ratios because they can deform plastically to absorb energy. In addition, thermoplastics are inexpensive, recyclable and generally have low toxicity to workers during composite fabrication [9].

Some of the desired characteristics of CNT composites include high CNT volume fractions, good CNT alignment, long CNT length, and significant individualization of CNTs within the polymer matrix (i.e., significant dispersion of CNTs). Reported techniques can produce a few of these desired structural features, but not all of them simultaneously. For example, a matrix-infusion method was developed to infuse epoxy resin into CNT preforms (or “films” or “buckypaper” or “mats”) with thousands of layers of CNT sheets pulled from CNT arrays to produce high volume fraction aligned-CNT composites [10-11]. Another method for producing high volume fraction aligned-CNT composites is shear pressing in which epoxy is infused into dense aligned-CNT preforms produced by shear pressing vertically aligned CNT arrays [12]. Multi-walled carbon nanotube (“MWNT”) sheets were pre-stretched and functionalized to produce composites with a bismaleimide (BMI) matrix [13]. These composites demonstrated the highest reported tensile strength and electrical properties, but exhibited low ductility [14] and the CNTs in the buckypaper sheets are curved or wavy. Matrix-infusion methods are successful in producing CNT-thermosetting polymer matrix composites because the small thermosetting monomers infuse into nanoscale structure before cross-linking. However, since the polymer is incorporated after the formation of the CNT structure, the polymer is not able to penetrate into areas where CNTs experience significant bundling.

Most high volume fraction composites have been produced with thermosetting polymer matrices (e.g., BMI, epoxy, etc.). Often, the strain-to-failure ratios of these composites are low, thus under-utilizing the high strain-to-failure ratios of CNTs. It is much more challenging to produce CNT-thermoplastic composites (as compared to CNT-thermosetting composites) with the desired structural characteristics, for the reasons set forth above. High mass-fraction CNT composites have been produced by solution or melt processing, but the CNTs were randomly oriented and poorly dispersed [15-18]. In-situ polymerization can achieve good dispersion of CNTs in thermoplastics but cannot align CNTs [19-21]. Injection molding and hot drawing can effectively align CNTs, but only at low CNT volume fractions and short CNT lengths [22-25]. The layer-by-layer (“LBL”) method is an effective way to process highly homogeneous, high volume-fraction CNT composites [26-27]. Through the application of a high magnetic field during the process, relatively short SWNTs were successfully aligned in polyelectrolyte. The electrical conductivity of the composites showed great improvement, while desirable mechanical properties are not yet available [28]. LBL-processed single-walled nanobube (“SWNT”)/polyvinyl alcohol (“PVA”) composites have been fabricated. SWNT/PVA composites demonstrated a tensile strength of 500MPa with no preferential CNT alignment [29]. In addition, the LBL process is time consuming

Studies of CNT composites so far have largely focused on improving the nanotube dispersion quality and functionalizing the interface with the polymer matrix [30-32]. To achieve good quality CNT/polymer dispersion, short CNTs in low volume fractions are typically required and utilized. Although short CNT composites have some advantages in certain low volume fraction applications, such as thermally and electrically conducting materials, their mechanical properties have typically fallen far short of traditional high performance structural composites. This results largely from the short CNT length (e.g., less than 10 μm), which cannot efficiently transfer a mechanical load across the weakly bonded interface. Chemical modification may improve interfacial shear strength at the expense of introducing defects in the CNT structures, thus degrading the properties [33-34]. Achieving high volume fractions of dispersed CNTs in polymer is difficult because the resulting high viscosity complicates further processing.

Another approach that has been used for fabricating CNT composites is reinforcing with CNT fiber assemblies [35-37], which include plied or braided CNT fiber assemblies [35-36] and long spun fibers infiltrated by polymer [37]. The most significant component in these composites is the CNT fiber (or yarn). Techniques for making CNT fibers are classified into “liquid” methods [38-39], where CNTs are dispersed into a liquid and solution-spun into fibers, and “solid” methods [40-41], where CNTs are directly spun into ropes or yarns [42]. The last five years have seen rapid progress in the “solid” fiber spinning approach [43-51]. While the mechanical properties of these fibers are promising, they both have limitations. The “liquid” method requires short CNTs for solution spinning, which limits the mechanical properties, while the “solid” method involves fiber twisting, which is a slow and expensive process.

Accordingly, there is a need for new, high-valued, industrially applicable CNT composites, as well as efficient methods for making CNT composites that are conducive to industrial scale-up, where the CNT composites exhibit excellent structural characteristics (e.g., high CNT volume fraction (and/or high CNT mass fraction), good CNT alignment, reduced CNT waviness, long CNT length, good CNT/polymer matrix bonding, etc.), and excellent mechanical and/or electrical properties (e.g., high tensile strength, high Young's modulus, high electrical conductivity, high toughness, good thermal conductivity, etc.).

### SUMMARY

To address the foregoing problems, in whole or in part, and/or other problems that may have been observed by persons skilled in the art, the present disclosure provides compositions, methods, processes, systems, apparatus, instruments, and/or devices, as described by way of example in implementations set forth below.

According to one implementation, a method is provided for fabricating a carbon nanotube (CNT) composite. An array of CNTs is provided. A CNT ribbon is pulled from the array and wound on a rotating mandrel. A polymer solution is applied to the CNT ribbon as the CNT ribbon is pulled from the array and wound on the mandrel to form a CNT composite laminate. The CNTs in the CNT ribbon may be substantially aligned in a single direction. The CNT ribbon may be attached to the mandrel such that the CNT ribbon may be wound on the mandrel as the mandrel rotates. The polymer solution may comprise a polymer and a solvent.

In some implementations, the polymer solution may be applied to the CNT ribbon by passing the CNT ribbon through a solution path including the polymer solution.

In some implementations, the polymer solution may be applied to the CNT ribbon by spraying the polymer solution on the CNT ribbon.

In some implementations, the mandrel and/or the CNT array may oscillate along a horizontal axis to obtain a predetermined width associated with the CNT composite laminate.

In some implementations, the CNT ribbon may be heated and/or stretched prior to applying the polymer solution to the CNT ribbon. The CNT ribbon may be stretched by pulling the CNT ribbon into contact with at least one tensioning rod.

In some implementations the CNT composite laminate may be removed from the mandrel and subsequently heated and/or stretched.

According to another implementation, a CNT composite is provided. The CNT composite may include a polymer integrated with long, substantially straight CNTs that are highly aligned in a single direction. The CNT composite may have a Young's modulus ranging from about 14 GPa to about 500 GPa. The CNT composite may have a tensile strength ranging from about 0.22 GPa to about 10 GPa.

In some implementations, the CNT composite may have an electrical conductivity ranging from about 140 S/cm to about 5000 S/cm.

In some implementations, the CNT composite may have a thermal conductivity ranging from about 10 W*m⁻¹K⁻¹ to about 400 W*m⁻¹K⁻¹.

In some implementations, the CNT composite may have a toughness ranging from about 16 J/g to about 250 J/g.

In some implementations, the CNT composite may include a thermosetting polymer.

In some implementations, the CNT composite may include a thermoplastic polymer.

According to another implementation, an apparatus for fabricating a CNT composite is provided. The apparatus may include a rotatable mandrel and a spray gun. The rotatable mandrel may be configured for taking up a CNT ribbon from an array of CNTs. The spray gun may be configured for spraying a polymer solution on the CNT ribbon as the CNT ribbon is taken up on the rotating mandrel.

In some implementations, the apparatus may include at least one tensioning rod configured for stretching the CNT ribbon as the CNT ribbon is pulled into contact with the tensioning rod.

Other compositions, devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1a shows the tensile strength of CNT/PVA composites as a function of the mass fraction of CNTs in the CNT/PVA composites. The corresponding PVA solution concentrations are labeled.

FIG. 1b shows thermogravimetric analysis (TGA) curves of pure CNT arrays, pure PVA polymer, and CNT/PVA composites fabricated with varying PVA solution concentrations. The mass fractions were estimated using TGA results at 600° C.

FIG. 1c shows stress-strain curves of a pure CNT film and three different CNT/PVA composites, under different ambient humidity.

FIG. 2a shows the normalized intensity of G-band peak versus the angle between the sample's longitudinal direction and the polarization axis of the incident laser beam. The normalized intensity at 90° becomes smaller when PVA is introduced into the CNT/PVA composite and further decreases after hot pressing.

FIG. 2b shows Raman spectra at 0° and 90°, before and after hot pressing the CNT/PVA composite. All of the CNT/PVA composites were fabricated using 1-g/L PVA solution.

FIG. 3a is a scanning electron microscope (SEM) image of a cross-section of a CNT/PVA composite fabricated with a PVA solution concentration of 0.5 g/L.

FIG. 3b is a SEM image of a cross-section of a CNT/PVA composite fabricated with a PVA solution concentration of 1 g/L.

FIG. 3c is a SEM image of a cross-section of a CNT/PVA composite fabricated with a PVA solution concentration of 2 g/L.

FIG. 3d is a SEM image of a side view of a CNT/PVA composite fabricated with a PVA solution concentration of 0.5 g/L.

FIG. 3e is a SEM image of a side view of a CNT/PVA composite fabricated with a PVA solution concentration of 1 g/L.

FIG. 3f is a SEM image of a side view of a CNT/PVA composite fabricated with a PVA solution concentration of 2 g/L.

FIG. 4 shows a comparison of electrical conductivities of CNT/PVA composites fabricated with increasing PVA solution concentrations as a function of the PVA mass fraction.

FIG. 5 is a schematic view of an example of an apparatus for fabricating CNT composites.

FIG. 6 is an image of an actual apparatus for fabricating CNT composites.

FIG. 7a is an image of another implementation of an apparatus for fabricating a CNT composite.

FIG. 7b is a schematic view of an apparatus for forming CNT composites using the apparatus of FIG. 7a.

FIG. 7c is an image of a local heating device that may be used to heat the CNT composite formed according to the process shown in FIG. 7b.

FIG. 7d is a schematic view of a method for locally heating and stretching the CNT composite made according to the process shown in FIG. 7b.

FIG. 8 shows Raman spectrum of CNTs prepared by a one-step CVD method and used to make CNT composites, and the inset shows a transmission electron microscope (TEM) image of a typical CNT prepared by the one-step CVD method.

FIG. 9 is an image of a flexible CNT/nylon 6,6 composite (before stretching) made with the apparatus shown in FIG. 7b.

FIG. 10a is an SEM image of an as-drawn dry CNT ribbon showing wavy CNTs.

FIG. 10b is an SEM image of a stretched CNT dry ribbon showing reduced CNT waviness.

FIG. 10c is an SEM image of a non-stretched CNT/nylon 6,6 composite showing wavy CNTs. The nylon matrix was decomposed in a TGA instrument.

FIG. 10d is an SEM image of a post-stretched CNT/nylon 6,6 composite showing enhanced alignment and reduced waviness of CNTs. The nylon matrix was decomposed in a TGA instrument.

FIG. 11a shows typical stress-strain curves of post-strained CNT/nylon 6,6 composites, pure CNT ribbon, and pure polymer.

FIG. 11b shows a comparison of tensile strength and Young's modulus of CNT/nylon composites with varying stretch ratios.

FIG. 12a is an SEM image of the fracture surface of a CNT/nylon 6,6 composite that was stretched according to a 7% stretch ratio.

FIG. 12b is an SEM image of sheath-core tips of MWNTs used to make CNT/nylon 6,6 composites.

FIG. 13 shows TGA curves of: a stretched CNT/BMI composite made with a BMI polymer solution having a BMI concentration of 1 g/L; pure BMI; and pure CNTs.

FIG. 14a shows a comparison of the tensile strength and Young's modulus of: stretched CNT/BMI composites made according to the present invention; the best engineering carbon fiber reinforced polymer (CFRP) composites; and previously reported CNT composites. All of the text in FIG. 14a corresponds to composites other than fibers. The blue filled squares represent the tensile strength and Young's modulus of currently existing high-strength CFRP, and the green-filled diamonds represent the tensile strength and Young's modulus of currently existing high-modulus CFRP. The unfilled gray circles represent previously reported CNT composites.

FIG. 14b shows a comparison of the specific tensile strength and specific Young's modulus of: stretched CNT/BMI composites made according to the present invention; and the best engineering carbon fiber reinforced polymer (CFRP) composites. The data are calculated based on a density of 1.6 g/cm³ for CFRP (60 vol. %), and 1.4 g/cm³ for CNT/BMI composites made according to the present invention (46 vol. %).

FIG. 15a is an SEM image of an as-drawn CNT ribbon from a free-standing CNT array. The inset is a TEM image of a CNT in the CNT ribbon, having a diameter of about 7 nm.

FIG. 15b is an image of an apparatus used to make CNT/BMI composites, showing CNT sheets (of CNT ribbon drawn from the array) that are successively stretched by two cylindrical copper wires (tensioning rods) before uptake on the rotating spool. The tensioning rods are highlighted by red circles.

FIG. 15c shows test specimens of CNT/BMI composites fabricated according to the present invention.

FIG. 15d is a schematic of a method for producing CNT composites using the apparatus shown in FIG. 15b.

FIG. 16a is an SEM image of CNT/BMI composites made without stretching, showing wavy CNTs and the microscale porous structure of the CNT sheets.

FIG. 16b is a high magnification SEM image of the composite shown in FIG. 16a.

FIG. 16c is an SEM image of a CNT/BMI composite made according to the method shown in FIG. 15d, showing straight and intimately contacting CNTs.

FIG. 16d is a high magnification SEM image of the composite shown in FIG. 16c.

FIG. 17a shows Raman spectra at 0° and 90°, for the most stretched sample of CNT/BMI composite made according to the method shown in FIG. 15d.

FIG. 17b shows the normalized intensity of G-band peak versus the angle between the CNT/BMI composite sample's longitudinal direction and the polarization axis of the incident laser beam. The intensity ratio R(R=I_{G∥}/I_{G⊥}) for CNT/BMI composites made without stretching increased to 2.3 and that for CNT/BMI composites made with stretching increased dramatically to 7.6, showing that stretching process imparted a significant alignment factor to the material. The CNT/BMI composites were made with a BMI solution concentration of 1 g/L.

FIG. 18a shows typical stress-strain curves of pristine CNT sheets and CNT/BMI composites with various polymer matrix concentrations.

FIG. 18b shows typical stress-strain curves of CNT/BMI composites with and without stretching, showing significant improvement of mechanical properties through alignment and straightening of CNTs.

FIG. 18c shows a comparison of tensile strength and Young's modulus for CNT/BMI composites made without stretching (R-winding), with stretching before winding (S-winding), and with stretching before winding and after winding (S-winding+P).

FIG. 19a is an SEM image of the typical fracture surface morphology of CNT/BMI composites made with a BMI solution concentration of 2.5 g/L (without stretching).

FIG. 19b is an SEM image of the typical fracture surface morphology of CNT/BMI composites made with a BMI solution concentration of 1 g/L (without stretching).

FIG. 19c is an SEM image of the typical fracture surface morphology of CNT/BMI composites made with a BMI solution concentration of 0.5 g/L (without stretching).

FIG. 19d is an SEM image of the typical fracture surface morphology of CNT/BMI composites made with a BMI solution concentration of 1 g/L (with stretching before winding).

FIG. 20a is a comparison of electrical conductivities measured in the direction of CNT alignment of CNT/BMI composites made with varying BMI solution concentrations. S stands for stretching prior to winding, and P stands for stretching both before and after winding.

FIG. 20b shows the regional strain-conductivity relationship of the resultant unidirectional CNT/BMI composites at a strain range of 0 to about 0.2%.

FIG. 20c shows an overview of the strain-conductivity relationship of the resultant unidirectional CNT/BMI composites at a strain range of 0 to about 1.5%.

FIG. 20d shows tensile strength behavior of the CNT/BMI composites along with in-situ conductivity testing. The increase in Young's modulus shows improved alignment during tensile loading.

FIG. 21 shows tensile strength curves for multiple CNT/BMI composite samples made according to the method shown in FIG. 15d, indicating the consistency of test samples and methods.

FIG. 22 shows large samples of CNT/BMI composites made according to the present invention.

FIG. 23 shows a CNT ribbon having a width of 10 mm being sprayed with polymer solution and wound on a mandrel according to one implementation.

### DETAILED DESCRIPTION

The present invention relates to carbon nanotube (CNT) composites with improved structural characteristics and mechanical properties, methods for making CNT composites, and apparatus and/or systems for producing CNT composites. CNT composites according to the present teachings may include, inter alia, one or more of the following microstructural features that lead to exceptional mechanical properties: (1) high CNT volume fraction; (2) good CNT alignment; (3) reduced CNT waviness; (4) long CNT length; and (5) good CNT/polymer matrix bonding.

For purposes of the present teachings, it will be understood that when a layer (or film, region, substrate, sheet, component, device or the like) is referred to as being “on” or “over” another layer, that layer may be directly or actually on (or over) the other layer or, alternatively, intervening layers (e.g., buffer layers, transition layers, interlayers, electrodes interconnects, or the like) may also be present. A layer that is “directly on” another layer means that no intervening layer is present, unless otherwise indicated. It will also be understood that when a layer is referred to as being “on” (or “over”) another layer, that layer may cover the entire surface of the other layer or only a portion of the other layer. It will be further understood that terms such as “formed on” or “disposed on” are not intended to introduce any limitations relating to particular methods of material transport, deposition, fabrication, surface treatment, or physical, chemical, or ionic bonding or interaction.

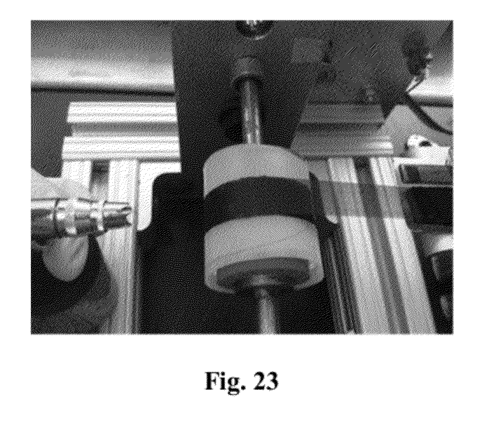

As used herein, the term “CNT array” refers to a structure of high density, vertically standing, long CNTs that are formed on a substrate (e.g., silicon, glass, quartz, etc.) via a chemical vapor deposition (CVD) method, or any other suitable method known to those skilled in the art. The dimensions of the CNT array may be dependent on the size of the substrate on which the CNT array is formed. For example, the CNT array may be formed on a silicon wafer having a diameter of from about 2 inches to about 4 inches, or in some implementations, up to about 12 inches or greater. In one particular yet non-limiting example, the CNT array may be formed on a quartz substrate having a width of about 1 inch and a length of about 2 inches. A CNT ribbon (or “CNT sheet”) may be drawn from the CNT array (e.g., via a rotating mandrel, a moving substrate, or the like). Each CNT ribbon layer may contain millions of well aligned CNTs. In some implementations, the CNT ribbon may be about 1 micron thick or greater, and may have a width ranging from about 1 mm to about 10 mm (see FIG. 23, which shows a CNT ribbon having a width of 10 mm). In some implementations, the width of the CNT ribbon may be up to about 12 inches or even greater, depending on the size of the substrate used that is used to form the CNT array from which the CNT ribbon is drawn.

The CNTs utilized in conjunction with the present teachings may be single-walled carbon nanotubes (SWNTs) or multi-walled carbon nanotubes (MWNTs), there being no limitation on the number of walls in the CNTs. For example, CNTs having three (3) or four (4) walls may have an outer diameter ranging from about 6 nm to about 8 nm. CNTs having five (5) or six (6) walls may have an outer diameter ranging from about 7 nm to about 10 nm. As another non-limiting example, CNTs having 50 walls may have an outer diameter of about 45 nm. As used herein, the term “long CNTs” may be used to refer to CNTs having a length of about 300 microns or greater.

Some non-limiting examples of polymers that may be utilized in solution to prepare CNT composites according to the present teachings may include: polyvinyl alcohol (PVA), poly(ethylene oxide) (PEO), poly(vinyl pyrrolidone) (PVP), nylon, polyurethane (PU), polystyrene (PS), poly(methyl methacrylate) (PMMA), polyethylene (PE), polypropylene (PP), poly(ethylene terephthalate) (PET), polyacrylamide, bismaleimide (BMI), various epoxy resins, polyimide, and the like. More generally, CNT composites according to the present teachings may be fabricated with various thermosetting polymers and/or thermoplastic polymers, depending on the potential application of the CNT composite (e.g., in general, thermoplastic polymers may be described as flexible, whereas thermosetting polymers may be described as stiff).

The present teachings describe methods (some of which may generally be referred to herein as a “spray winding method”) for fabricating high strength CNT composites having highly aligned CNTs in a single direction, substantially straight CNTs (i.e., non-wavy CNTs), long CNTs (i.e., greater than about 300 microns in length), high CNT volume fractions (and/or high CNT mass fractions), good CNT/polymer matrix bonding, and/or highly dispersed CNTs within the polymer matrix. In some implementations, the CNT composites possess two or more of the foregoing attributes. In some implementations, the CNT composites possess all of the foregoing attributes. All of these structural characteristics may be achieved without functionalizing the CNTs in the composite. The spray winding method generally includes providing an array of CNTs that are substantially aligned in a single direction. A CNT ribbon may be pulled from the array by a rotating mandrel to which the CNT ribbon is attached. As the mandrel rotates, the CNT ribbon is wound on the mandrel (e.g., a cylindrical polytetrafluoroethylene (PTFE) spool or any other suitable rotatable apparatus for taking up the CNT ribbon). As the CNT ribbon is pulled from the CNT array and wound on the mandrel, a polymer solution (i.e., polymer and a solvent) may be sprayed on the CNT ribbon (or otherwise applied to or deposited on the CNT ribbon, such as by passing the CNT ribbon through a polymer solution bath). As the sprayed CNT ribbon is wound on the mandrel, layers of sprayed CNT ribbon are formed on the mandrel. It will be understood that the term “CNT composite laminate” may be used herein to refer to layers of CNT ribbon that have been sprayed and wound on the mandrel, and encompasses implementations in which a thermosetting polymer is utilized, as well as implementations in which a thermoplastic polymer is utilized. In implementations in which the polymer is a thermosetting polymer, the CNT composite laminate may be considered by those skilled in the art as a CNT prepreg. Those of skill in the art will appreciate that subsequent curing of the CNT prepreg (e.g., heating the CNT prepreg to a suitable temperature for a suitable length of time) may be carried out in some implementations. The CNT composite laminates may be stacked to form CNT composites with suitable dimensions.

In some implementations, the polymer solution may be sprayed by a compressed air sprayer (such as a fine-line air sprayer), or any other suitable sprayer that is adjustable and capable of accurately spraying the polymer solution on the CNT ribbon. However, it will be understood that polymer solution may be applied to the CNT ribbon by any suitable method, such as by passing the CNT ribbon through a polymer solution bath. A screen may be positioned between the nozzle of the sprayer and the mandrel, and the polymer solution may be sprayed through an opening in the screen to ensure that polymer solution is sprayed only on the CNT ribbon. The present invention encompasses implementations in which the polymer solution is sprayed on the CNT ribbon as the CNT ribbon is pulled from the array, but before the CNT ribbon starts to wind on the mandrel. As an alternative, or in addition to the foregoing, the polymer solution may be sprayed on the CNT ribbon as the CNT ribbon is being wound on the mandrel. The phrase “spraying a polymer solution on the CNT ribbon as the CNT ribbon is pulled from the array and wound on the mandrel” is meant to encompass the foregoing temporal limitations associated with spraying and/or winding. In some implementations, the mandrel and/or the CNT array may be movable (e.g., in the horizontal direction) such that the sprayed CNT ribbon (or CNT sheet) may be layered on the mandrel to a selected width (e.g., to a width greater than the width of the CNT ribbon). One or more parameters associated with the spray winding process may be adjusted in order to achieve a desired volume fraction of CNTs within the CNT composite. Examples of the parameters that may be adjusted include: the concentration of the polymer in the polymer solution; the speed of the rotating mandrel (and thus the speed at which the CNT ribbon is drawn from the CNT array); and/or the rate at which the polymer solution is applied to the CNT ribbon (e.g., the flow rate of polymer solution out of the sprayer, or “spray throughput”). In one specific yet non-limiting example, the CNT ribbon may be pulled from the array at a rate of about 18 mm/s to about 19 mm/s As another example, the concentration of the polymer in the polymer solution may range from greater than 0 g/L to about 10 g/L. In some implementations, the concentration of the polymer in the polymer solution may be as high as 500 g/L. The spray winding process may be carried out until a predetermined (i.e., desired or selected) value for any one (or more) of a variety of parameters associated with the CNT composite laminate is achieved (e.g., a particular length of CNT ribbon has been pulled from the array; a particular width of the CNT composite laminate is achieved; a predetermined thickness of the CNT composite laminate is achieved; etc.)

The CNT composite laminate may be removed from the mandrel and further processed. For example, the CNT composite laminate may be heated in a hot press (e.g., between heated plates) or placed in an autoclave to remove air voids and to obtain optimal integration of the polymer matrix and CNTs, and/or the CNT composite laminate may be stretched. Those of skill in the art will appreciate that the temperature to which the CNT composite laminate is heated may depend on the type of polymer utilized (i.e., whether the polymer is thermoplastic or thermosetting). For example, when thermoplastic polymers are utilized, the CNT composite laminate may be heated to a temperature that is above the glass transition temperature of the thermoplastic polymer, but below the melting temperature of the thermoplastic polymer. When thermosetting polymers are utilized, the CNT composite laminate may be heated to a temperature that is below the curing temperature of the thermosetting polymer (so that the thermosetting polymer is only partially cured, and the polymer molecules may be reconfigured and realigned with the CNTs). In some implementations, the CNT composite laminate may be heat pressed to a temperature of about 160° C. to about 180° C. In implementations in which a thermosetting polymer is utilized, the CNT composite laminate may be removed from the mandrel and heat pressed up to a temperature of about 450° C., for example.

As mentioned above, either alone or in addition to heating the CNT composite laminate, the CNT composite laminate may be stretched to reduce waviness of CNTs in the CNT composite laminate (leading to improved mechanical and/or electrical properties of the CNT composites as discussed below in conjunction with Examples 2-3). For example, the CNT composite laminate may be simultaneously stretched (e.g., on a tensile tester or any other suitable stretching apparatus known to those skilled in the art) and heated. In some implementations, the CNT composite laminate may be heated by a local heating source while the CNT composite laminate is being stretched. The local heating source may be movable and may include, for example, a heating element with dual extended prongs. The movable heating source may locally heat the CNT composite laminate to a temperature that, again, depends on the type of polymer utilized (e.g., up to about 160° C. to about 180° C., or up to 450° C.). In one non-limiting example, the heating element may be moved along the CNT composite laminate at a speed of about 3 mm/s, and the CNT composite laminate may be uniformly stretched along the length of the CNT composite laminate (i.e., the direction of alignment of the CNTs in the CNT composite laminate) at a stretch rate of 0.1 mm/min. It will be understood that the heating element may be moved along the length of the CNT composite laminate at any suitable speed, and the CNT composite laminate may be stretched at any suitable stretch rate. In some implementations, after stretching and locally heating the CNT composite laminate, the CNT composite laminate may be heat pressed (as discussed above). In various implementations, the CNT composite laminate may be stretched according to a stretch ratio (i.e., (L_{S}-L_{US})/L_{US}, where L_{S} is the length of the stretched CNT composite laminate and L_{US} is the length of the CNT composite laminate before stretching) ranging from greater than 0% to about 7% or greater (e.g., 100%), depending on how many CNTs in the CNT composite laminate are straightened.

In some implementations, the spray winding process may include stretching the CNT ribbon prior to being sprayed with polymer solution. For example, as the CNT ribbon is pulled from the array, the CNT ribbon may be pulled through a tensioning system before being wound on the mandrel. The tensioning system may include at least one tensioning rod (e.g., a cylindrical copper wire) for applying tension to the CNT ribbon as the CNT ribbon is pulled at least partially around the tensioning rod and subsequently wound around the mandrel. Pulling the CNT ribbon through the tensioning system may straighten the CNTs or CNT bundles in the CNT ribbon in the direction in which the CNT ribbon is pulled.

CNT composites according to the present teachings exhibit excellent structural characteristics and superior mechanical and/or electrical properties. The CNT composites of the present teachings include a polymer and long (i.e., a length of about 300 microns or greater), substantially straight CNTs that are highly aligned in a single direction. In addition, the CNTs in the CNT composites are well-dispersed and well-embedded in the polymer matrix. As discussed above, the CNT composites may include thermosetting or thermoplastic polymers.

In various implementations, CNT composites according to the present teachings may have a Young's modulus ranging from about 14 GPa to about 500 GPa. In some implementations, the CNT composites may include a thermosetting polymer, and the CNT composites may have a Young's modulus ranging from about 216 GPa to about 500 GPa, or from about 216 GPa to about 350 GPa. In some implementations, the CNT composites may include a thermoplastic polymer, and the CNT composites may have a Young's modulus ranging from about 14 GPa to about 100 GPa. In one particular, yet non-limiting example, the CNT composites may include PVA, and the CNT/PVA composites may have a Young's modulus of about 100 GPa. In another non-limiting example, the CNT composites may include nylon 6,6, and the CNT/nylon 6,6 composites may have a Young's modulus of about 60 GPa. In another non-limiting example, the CNT composites may include BMI, and the CNT/BMI composites may have a Young's modulus of about 350 GPa.

In various implementations, CNT composites according to the present teachings may have a tensile strength ranging from about 0.22 GPa to about 10 GPa. In some implementations, the CNT composites may include a thermosetting polymer, and the CNT composites may have a tensile strength ranging from about 1.4 GPa to about 10 GPa, or from about 1.4 GPa to 4.0 GPa. In some implementations, the CNT composites may include a thermoplastic polymer, and the CNT composites may have a tensile strength ranging from about 0.22 GPa to about 2.0 GPa, or from about 1.3 GPa to about 2.0 GPa. In one particular, yet non-limiting example, CNT/PVA composites according to the present teachings may have a tensile strength of about 2.0 GPa. In another non-limiting example, CNT/nylon 6,6 composites according to the present teachings may have a tensile strength of about 1.0 GPa. In another non-limiting example, CNT/BMI composites according to the present teachings may have a tensile strength of about 4.0 GPa.

In various implementations, CNT composites according to the present teachings may have an electrical conductivity ranging from about 140 S/cm to about 5000 S/cm. In some implementations, the CNT composites may include a thermosetting polymer, and the CNT composites may have an electrical conductivity ranging from about 820 S/cm to about 1230 S/cm. In some implementations, the CNT composites may include a thermoplastic polymer, and the CNT composites may have an electrical conductivity ranging from about 140 S/cm to about 781 S/cm, or from about 520 S/cm to about 781 S/cm. In one particular, yet non-limiting example, CNT/PVA composites according to the present teachings may have an electrical conductivity of about 781 S/cm. In another non-limiting example, CNT/nylon 6,6 composites according to the present teachings may have an electrical conductivity of about 420 S/cm. In another non-limiting example, CNT/BMI composites according to the present teachings may have an electrical conductivity of about 1230 S/cm.

In various implementations, CNT composites according to the present teachings may have a thermal conductivity ranging from about 10 W*m⁻¹K⁻¹ to about 400 W*m⁻¹K⁻¹. In some implementations, CNT/BMI composites according to the present teachings may have a thermal conductivity ranging from about 10 W*m⁻¹K⁻¹ to about 400 W*m⁻¹K⁻¹.

In various implementations, CNT composites according to the present teachings may have a toughness ranging from about 16 J/g to about 250 J/g. In some implementations, the CNT composites may include a thermosetting polymer, and the CNT composites may have a toughness ranging from about 16 J/g to about 46 J/g. In some implementations, the CNT composites may include a thermoplastic polymer, and the CNT composites may have a toughness ranging from about 65 J/g to about 112 J/g. In one particular, yet non-limiting example, CNT/PVA composites according to the present teachings may have a toughness of about 112 J/g. In another non-limiting example, CNT/BMI composites according to the present teachings may have a toughness of about 46 J/g.

In one particular, yet non-limiting example, CNT/BMI composites according to the present teachings may have a CNT volume fraction ranging from about 46% to about 60%. In another non-limiting example, CNT/nylon 6,6 composites according to the present teachings may have a volume fraction of about 15%.

In one particular, yet non-limiting example, CNT/BMI composites according to the present teachings may have a specific strength (i.e., the tensile strength of the CNT composite divided by the density of the CNT composite) ranging from about 25*10⁶ cm to about 30*10⁶ cm. In another particular, yet non-limiting example, CNT/BMI composites according to the present teachings may have a specific Young's modulus (i.e., the Young's modulus of the CNT composite divided by the density of the CNT composite) ranging from about 18*10⁸ cm to about 22*10⁸cm.

In some implementations, the CNT composites may include a thermoplastic polymer, and the CNT composites may have a CNT mass fraction ranging from about 28% to about 78%. In one particular, yet non-limiting example, CNT/PVA composites according to the present teachings may have a CNT mass fraction of about 78%. In another non-limiting example, CNT/nylon 6,6 composites according to the present teachings may have a CNT mass fraction of about 20%. In another non-limiting example, CNT/BMI composites according to the present teachings may have a CNT mass fraction of about 50%.

In some implementations, the CNT composites may include a thermosetting polymer, and the CNT composites may have a strain-to-failure ratio ranging from about 1.2% to about 10%. In some implementations, the CNT composites may include a thermoplastic polymer, and the CNT composites may have a CNT strain-to-failure ratio ranging from about 8% to about 13%. In one particular, yet non-limiting example, CNT/PVA composites according to the present teachings may have a strain-to-failure ratio of about 13%. In another non-limiting example, CNT/BMI composites according to the present teachings may have a strain-to-failure ratio of about 3.0%.

CNT composites according to the present teachings may be utilized in various applications. The particular application for which a CNT composite is utilized may depend on various factors, including whether the polymer in the composite is a thermosetting or thermoplastic polymer. Non-limiting examples of potential applications for the CNT composites of the present invention include high performance, ultra-strong multifunctional materials intended for: the automobile, marine and aeronautical industries; electromechanical actuators; cables; resistive wires; chemical detectors; the storage and conversion of energy; electron emitter displays, battery electrodes, electronic components and functional textiles. CNT composites according to the present teachings may be used to prepare strong and light armor for aircraft, missiles, space stations, space shuttles, and other high strength articles. CNT composites according to the present teachings may be supplied to manufacturers of high performance materials in various forms. For example, the CNT composites may be supplied in nanocomposite prepreg form for incorporation into high performance materials.

The following examples are intended to illustrate the invention, and are not intended to limit the scope of the invention.

### EXAMPLE 1

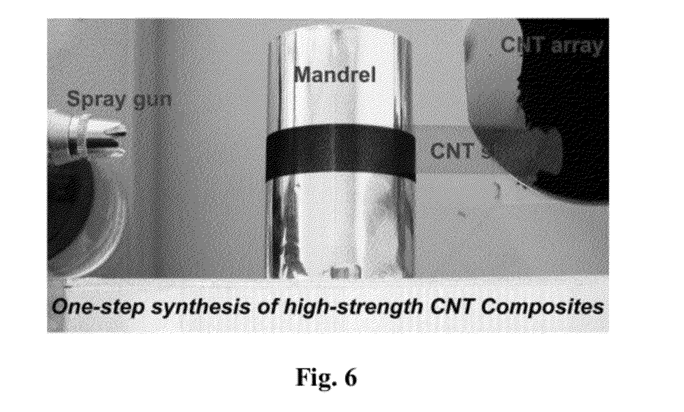

In this Example, CNT-thermoplastic polymer composites are produced according to a spray winding method (see FIGS. 5 and 6 for a schematic and an actual image of an apparatus that may be used to fabricate CNT composites according to the method of the present Example). The CNT-thermoplastic polymer composites exhibit high toughness (e.g., 112 J/g), high strength (e.g., 1.8 GPa) and good electrical conductivity (e.g., 781 S/cm). The Young's modulus of the composites ranged from 32 GPa to 46 GPa. The CNTs in the composites possess four salient features: high volume-fraction, high level of alignment, long length, and good integration with the polymer matrix. These features are important for producing high strength and toughness, and in the present Example may be achieved simultaneously. The spray winding method disclosed herein bypasses the technical bottleneck of slow CNT fiber spinning, and is therefore conducive to scaling-up for industrial production.

Experimental Procedure

Highly aligned CNT arrays were grown on an SiO₂/Si substrate with a catalyst of Fe/Al₂O₃. The vertically aligned CNT arrays have a uniform height of 300 μm, from which a layer of CNT ribbon was pulled out continuously. Each layer of CNT ribbon contains millions of well-aligned CNTs. Each CNT ribbon is about 1 μm in thickness and about 3-5 mm wide. Dilute PVA (Mw=85,000˜124,000, 99+% hydrolyzed) solutions were prepared by dissolving the polymer in a solvent containing equal parts of deionized water and ethanol. The polymer solution was sprayed under 10 psi air pressure onto the ribbons drawn at a speed of 19 mm/s, as the ribbons were wound on a mandrel with a diameter of 3 cm and a rotational speed of 11.5 rpm. A screen with a rectangular slit was kept between the nozzle (of the air sprayer) and mandrel to ensure that polymer solution was deposited only on the CNT ribbon. The solution droplets were micrometer-sized using a commercially available Badger 200NH airbrush. The composite films were prepared by rotating the mandrel for one hour, with a solution-dependent thickness of 10-20 μm. For the tensile tests, the films were cut into 1.5 cm×0 5 mm pieces and tested on a Shimadzu EZ-S testing machine with a load cell of 100 N at a strain rate of 8.3% per minute.

Conductivity results were calculated based on resistance, which were measured along the direction of alignment of the CNTs in the composite by an Agilent 34410A 6.5 digit multi-meter with 4 probe measurement.

The CNT mass fraction was calculated based on TGA analysis, which was completed on a Perkin Elmer Pyris 1 in nitrogen (99.999%) with a heating rate of 10° C. per minute. Based on results of TGA analysis of neat PVA polymer and pure CNT arrays, mass fractions of CNTs in CNT/PVA composites made with 2 g/L and 1 g/L polymer solution were calculated to be 65% and 78%, respectively.

Results and Discussion

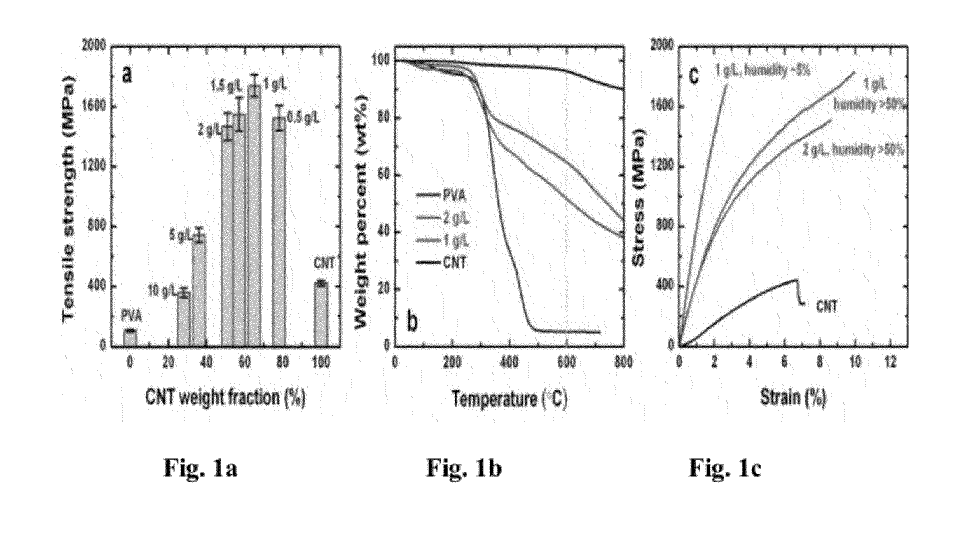

In the present Example, a spray winding method was used to fabricate CNT-thermoplastic composites with high, tunable CNT volume fractions. As the mandrel diameter, rotating speed, spray pressure, and the distance between the airbrush and the mandrel were fixed, CNT/PVA composites with different CNT mass fractions were achieved by using PVA solutions with different concentrations, namely 0.5, 1, 1.5, 2, 5, and 10 g/L. With increasing PVA solution concentration, the CNT mass fraction decreases. FIG. 1a shows the tensile strength as a function of the CNT mass fraction, which was estimated from the TGA curves (see FIG. 1b) [52]. The highest strength of the CNT/PVA composite (i.e., 1.82 GPa) was found for the composite having a CNT mass fraction of 65 wt %, where the CNT composite was fabricated using a 1 g/L PVA solution. The average strength among more than five samples taken from the strongest CNT composite was 1.74 GPa. These CNT composites were much stronger than previously reported CNT/PVA composites (e.g., 100-600 MPa) [53-55]. The strength was also much higher than that of composite fibers (1.2 GPa) including the same CNTs and PVA [56], and was comparable to that of the strongest CNT/PVA fiber (˜2.05 GPa) reported recently [52]. A better integration between CNTs and PVA may be obtained by the present spray winding method than by infiltration. However, the strength varies significantly with the change of the CNT mass fraction. Increasing the mass fraction to 78 wt %, by using a more dilute PVA solution (0.5 g/L), the strength decreased (1.52 GPa). With a CNT mass fraction of 28 wt %, the strength decreased significantly to 359 MPa, just 253 MPa higher than that of the pure PVA film. As shown in FIG. 1a, when the PVA solution concentration was low (i.e., from 0.5 g/L to 2 g/L) all of the composites were stronger than 1.5 GPa, indicating that the spray winding method is efficient for dilute solutions.

FIG. 1c provides the stress-strain curves for a pure CNT film (made by layering hundreds of CNT ribbons that are sprayed with a mixture of water and ethanol) and for three CNT/PVA composites made using the 1-g/L and 2-g/L PVA solutions. The pure CNT film was only 420 MPa in strength, due to the weak van der Waals interaction between CNTs. In the pure CNT film, CNTs might slide against each other under external loads. For example, in the tensile test there was a sudden drop of stress, corresponding to the sliding. When the PVA solution was sprayed onto the CNT ribbon, a stronger interaction between PVA and CNT was introduced, and the long and flexible polymer molecules may interact and bridge CNTs that are not in close contact. Therefore, the interfacial shear stress was improved greatly, resulting in the high tensile strength. Note that both the CNT film and the composites were densified due to the capillary force caused by the evaporation of the solvents.

The tensile behavior was also found to depend on the relative humidity (RH) (see the two red curves in FIG. 1c). When the RH is high, there is a large amount of water absorbed to increase the plasticity of the PVA matrix. As a result, the composite deforms more easily when stretched, as compared to composites including less water. The strongest CNT/PVA film had a strain to failure ratio of 10% when being tested under >50% RH, and a strain to failure ratio of 2.8% when the RH was 5%. Thus, the Young's modulus and toughness were also dependent on humidity. RH had negligible influence on tensile strength as the CNT-PVA interfaces were not changed. When measured under >50% RH, the Young's modulus was 40-56 GPa and the toughness ranged from 65 to 112 J/g, for the films stronger than 1.5 GPa. The toughness was much higher than that of the strongest CNT/PVA fiber [52], and higher than that of reported CNT/BMI composites [57]. A recent study showed a similar toughness (˜121 J/g) for a CNT/PVA composite via a layer-by-layer assembly [54]. However, this super-tough composite had a larger strain to failure ratio of 20-40% and a smaller strength of 504 MPa. Under the dry environment of 5% RH, the Young's modulus of the CNT composite in the present Example was doubled to 96 GPa, and the toughness was still large, up to 38 J/g. These results demonstrate the influence of matrix plasticity on the mechanical properties of the CNT composites.

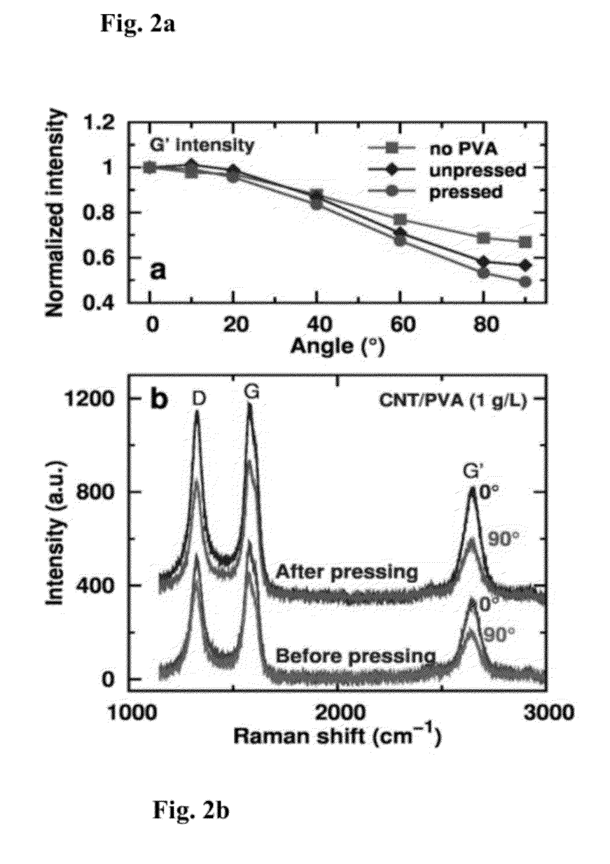

The high performance of our composites arises from the long CNT length and the high degree of alignment. As the CNT ribbon was pulled out from the CNT array, the CNT length of ˜300 μm (aspect ratio of ˜30000) was not changed and was one order of magnitude longer than the tubes that are normally used for dispersion in a polymer matrix [55,58], which is important for high-performance composites. Using long CNTs results in increased tensile strength, similar to spun CNT fibers [59]. Furthermore, the CNTs were aligned in the form highly aligned in the CNT array. The aligned structure may be investigated by polarized Raman spectroscopy [60, 61], as shown in FIG. 2a. For a pure CNT film, the normalized G′-band Raman intensity decreased to 0.669 when the angle between the film and the polarization axis of the incident laser beam was changed from 0° to 90°. The CNTs were not fully aligned due to their own waviness in the array [59] and the weak tube-tube interaction. As the PVA molecules were uniformly distributed within the CNT ribbon, the alignment could be further improved in the CNT composite. As shown in FIG. 2a, when PVA was present, the normalized G′ peak at 90° became smaller, to 0.566 before thermal pressing to densify the composite, and 0.493 after thermal pressing. This implies that the spray winding process has the potential to improve CNT alignment. In FIG. 2b, the Raman spectra of the strongest CNT/PVA composites are provided. Both the G′ band and the G band peaks decreased significantly for the hot-pressed CNT composite at the angle of 90°, indicating that the alignment had indeed been improved.

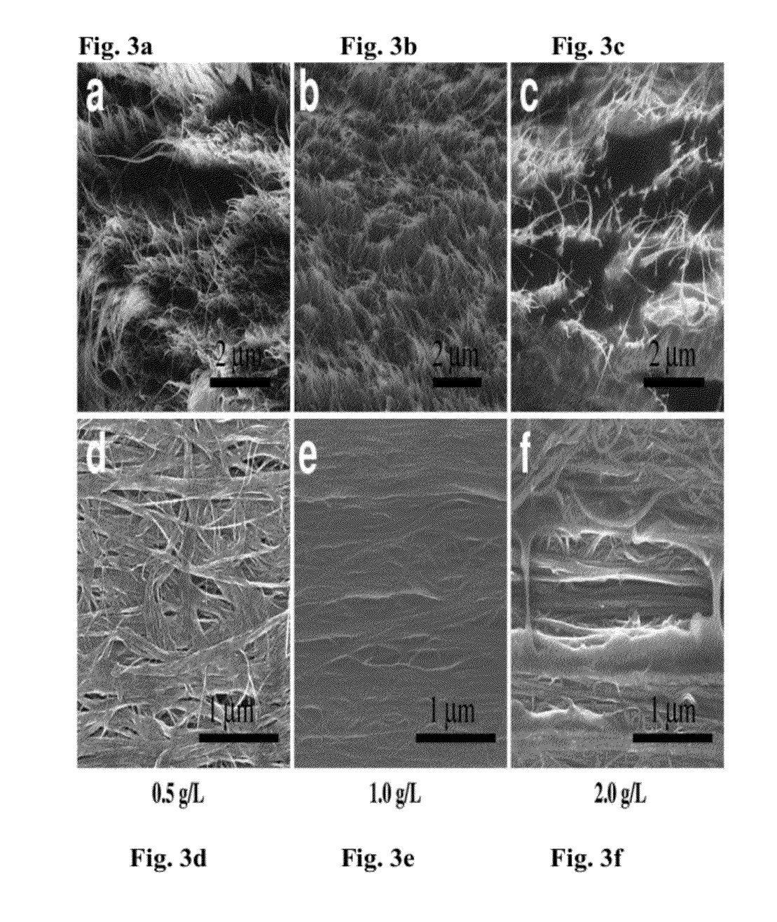

As discussed above, the tensile properties strongly depend on the CNT mass fraction. At a PVA solution concentration of 1 g/L, the CNT mass fraction was 65 wt %. FIGS. 3a-3c show scanning electron microscopy (SEM) images of the cross-sections of the CNT composites fabricated with PVA solution concentrations of 0.5-, 1-, and 2-g/L, respectively. FIGS. 3d-3f show SEM images of the side views of the CNT composites fabricated with PVA solution concentrations of 0.5-, 1-, and 2-g/L, respectively. Below a PVA solution concentration of 1 g/L, micrometer-sized voids were present within the CNT composite due to the lack of PVA matrix (see FIGS. 3a and 3d). These voids will act as defects that cause the CNT composite to fail prematurely. When high-concentration PVA solution was sprayed, there was excessive matrix around the tubes (see FIGS. 3c and 3f), which leads to low CNT volume fraction and consequently low strength. In contrast, a PVA solution concentration of 1-g/L produced a desired CNT composite structure with relatively high CNT volume fraction and no voids. This structure produced the highest composite strength, as shown in FIG. 2a.

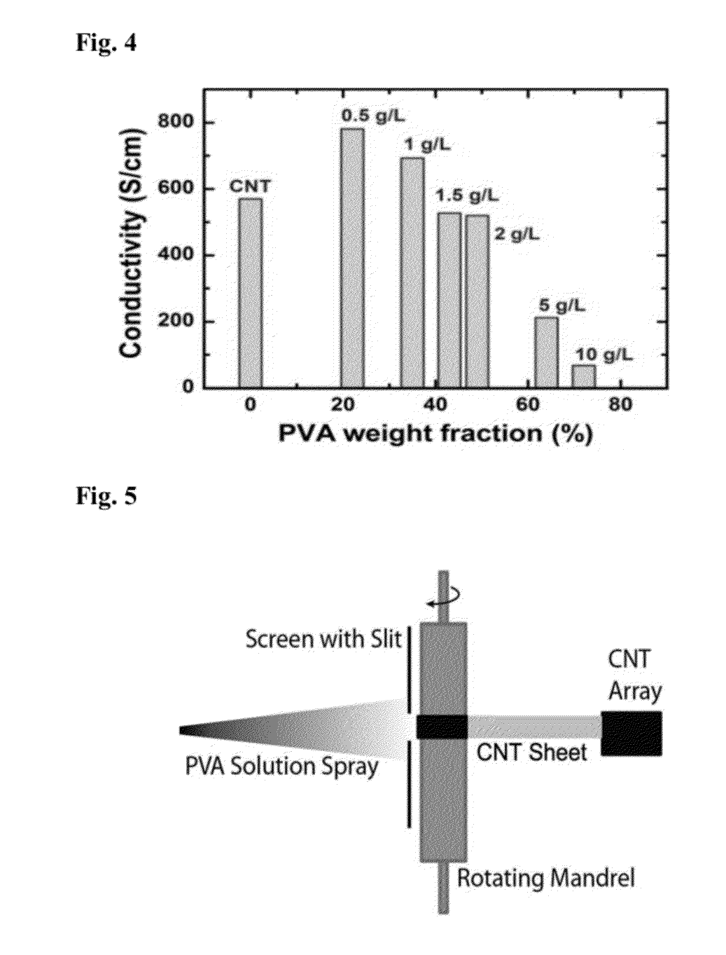

As shown in FIG. 4, The CNT/PVA composites are also good electrical conductors. For the CNT composites fabricated with 0.5- and 1-g/L PVA solutions, their respective electrical conductivities of 780 and 690 S/cm were larger than the pure CNT film (570 S/cm). The increase of the electrical conductivity may be attributed to the improved CNT-CNT contacts. When the PVA solution is sprayed onto the CNT ribbon, the capillary force produced by the solution draws neighboring tubes together. The PVA molecules help maintain the close contact after the evaporation of the solvents. Therefore the inter-tube contact area becomes larger and the contact resistance is reduced. A similar increase of electrical conductivity was also reported in CNT/PVA fibers by Liu et al. [52]. However, when a more dense PVA solution was used, the conductivity of the CNT composite decreased as the PVA wrapping around CNTs became dominant, which would degrade the inter-tube contact. This is demonstrated in FIG. 4, which shows a monotonic decrease in conductivity with increasing PVA concentration.

In summary, a spray winding method is disclosed in the present Example for fabricating CNT composites. The spray winding technique of the present Example produced CNT composites with the desired structural features, including high CNT volume fraction, long CNT length, improved CNT alignment, and a uniform distribution of PVA molecules among the CNT network. By using CNTs with a large aspect ratio of ˜30000, the strongest composite films had a tensile strength of ˜1.8 GPa, a Young's modulus of 40-96 GPa, and a toughness of 38-100 J/g. The production speed of the CNT composites depends on the rotation speed of the mandrel, and is much higher than the existing techniques such as the resin transfer molding [62] and the layer-by-layer assembly [54,63,64], making it conducive to large-scale production at low cost. Besides the thermoplastic PVA used here, the method of the present Example may also be used to make thermosetting polymer-based composites with ultrahigh mechanical properties.

### EXAMPLE 2

In this Example, we report an effective method for increasing the strength and stiffness of high volume fraction, aligned CNT composites by reducing CNT waviness using a mechanical stretching approach. Stretching the CNT composites after fabrication improved the ultimate strength by 50, 150, and 200%, corresponding to stretch ratios of 2, 4 and 7%, respectively. Improvement of the electrical conductivities exhibited a similar trend. These results demonstrate the importance of straightening and aligning CNTs in improving composite strength.

The present Example discloses uniformly winding CNT ribbons from free-standing CNT arrays, infusing a nylon 6,6 solution between layers of the CNT ribbon without disturbing the pre-existing alignment, followed by stretching the composite while locally heating it. The present Example identifies a mechanism for optimizing mechanical properties of CNT composites.

Experimental Procedure

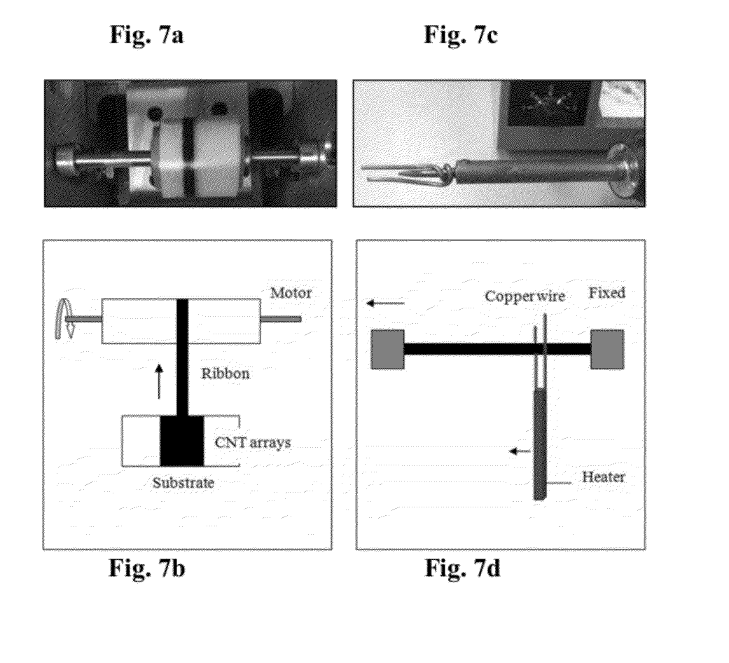

Vertically aligned CNT arrays with a height of ˜700 μm were synthesized on a quartz substrate with iron chloride (FeCl₂) powder using a thermal chemical vapor deposition (CVD) method described in the literature [65]. The CNTs (i.e., a ribbon of CNTs) were drawn from the arrays onto a rotating cylindrical polytetrafluoroethylene (PTFE) spool (as shown in FIG. 7a and FIG. 7b). Continuous CNT ribbons were placed on the rotating spool while tension was applied in order to improve alignment. Meanwhile, nylon 6,6 (density=1.14 g/cm³, molecular weight=262.35) solution (1 wt. % in phenol) was infused into the layers of the as-wound CNT ribbons using a dropper. After approximately 400 winding revolutions at a draw speed of 1.1 m/min, unidirectional CNT/nylon 6,6 composites (10 cm long, 0.5 cm wide and 20 μm thick) were produced.

The as-wound CNT/nylon 6,6 composite was removed from the PTFE spool. Precise stretching was performed on a tensile tester (Shimazu EZ-S). The composite was locally heated by a fabricated heating element with dual prongs. The temperature between the two extended wire ends (see FIG. 7c and FIG. 7d) reached approximately 160° C., which was measured by a thermocouple. The heating element moved along the composite at a speed of 3 mm/s so that the composite was heated and stretched uniformly along the CNT length direction at a speed of 0.1 mm/min. The low applied load and the moving local heating source ensured that the whole composite was stretched without premature failure. The stretched CNT composites were hot pressed in a vacuum oven at 160° C. for one hour. During the pressing process, residual solvent was evaporated and the polymer was softened. Pressed composites had higher tensile strength and Young's Modulus than those not pressed. It was assumed that the pressing minimized voids and defects in the individual layers so that more intimate contact between polymer and CNTs was developed.

Tensile test specimens were cut from the CNT/nylon 6,6 composites into strips that were approximately 10 mm long and 0.3 mm wide. CNT alignment was parallel to the longitudinal direction of the tensile loading. Sample width was measured using an optical microscope (30×) and the sample thickness was measured using a micrometer. The composite specimens with a gauge length of 6 mm were tested at room temperature using the tensile testing machine at a crosshead speed of 0.5 mm/min. Five specimens were tested for each CNT/nylon 6,6 composite. Resistance was measured using the four-probe method. Transmission electron microscopy (TEM) analysis of the nanotubes was performed using a JEOL 2010F microscope at an acceleration voltage of 200 kV. Scanning electron microcopy (SEM) analysis of the CNT ribbons and CNT composite fracture surface was carried out on a JEOL 6400F microscope with an acceleration voltage of 5kV. Thermogravimetric analysis (TGA) was completed on a Perkin Elmer Pyris 1 in nitrogen (99.999%) with a heating rate of 10° C. per minute.

Results and Discussion

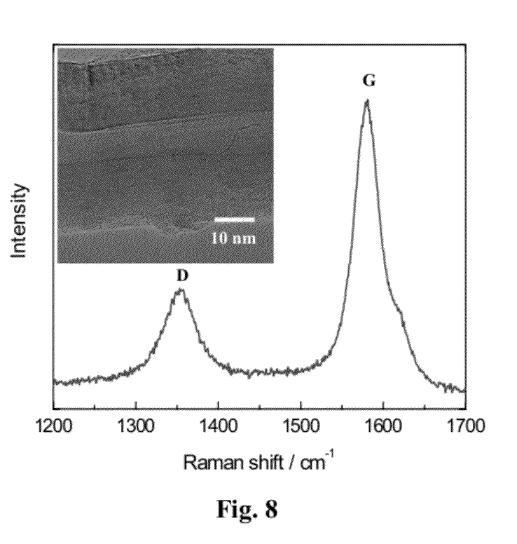

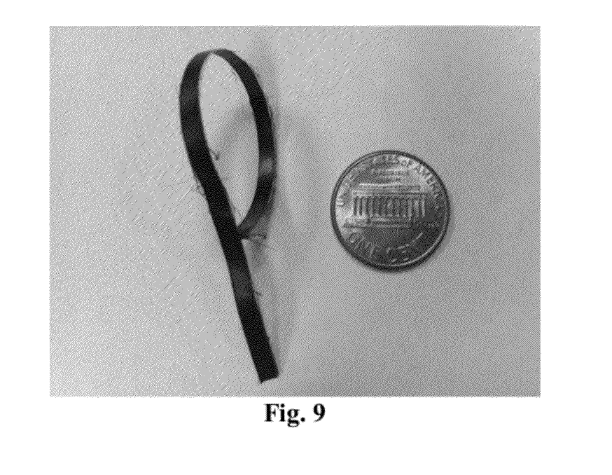

The CNTs used to fabricate the composites in the present Example were characterized by Raman spectroscopy and TEM (see FIG. 8). A sharp G band (due to graphitic carbon) at 1583 cm⁻¹ and a weak D band (due to disordered carbon) at 1357 cm⁻¹ were observed in the Raman spectrum, indicating that the as-synthesized nanotubes were well-crystallized. The TEM image shows a nanotube having 50 walls and a diameter of 45 nm (see inset in FIG. 8). These nanotubes were highly drawable from the array and have a high aspect ratio (about 50000), indicating a large interaction interfacial area with the polymer matrix. FIG. 9 is a photograph of a typical aligned CNT/nylon 6,6 composite as prepared according to the present Example.

Alignment of CNTs is a major issue for fabricating high performance composites [66, 67]. The drawing process aligns the CNTs by applying tension during uptake on the PTFE spool. In the present Example CNT ribbons are easily formed from the CNT array, which facilitates more rapid fabrication of large engineering structures. Although the CNTs were aligned, significant waviness is present and diminishes the mechanical strength.

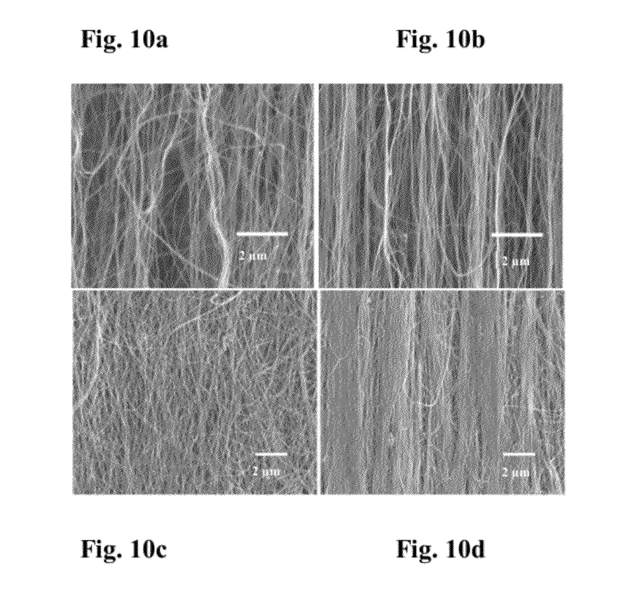

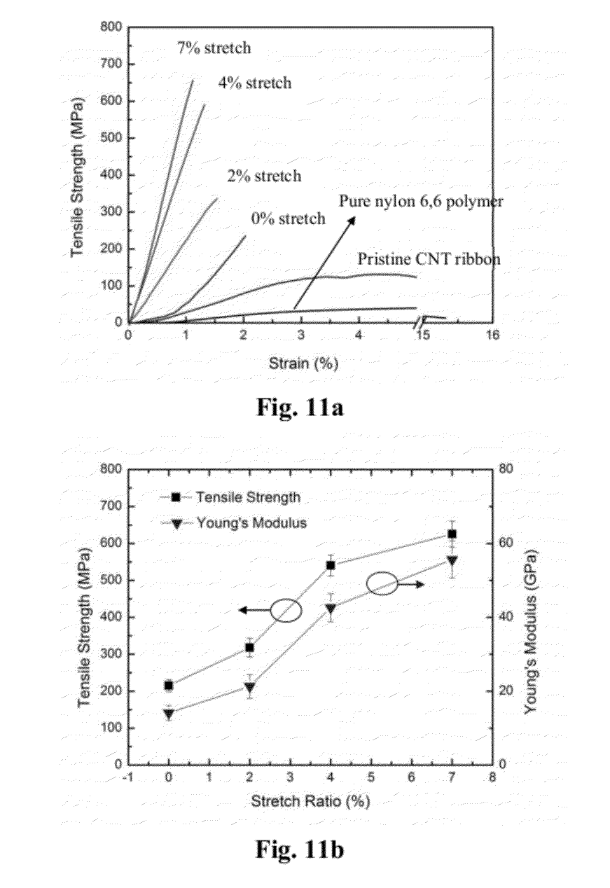

In order to maximize the load-carrying efficiency, the waviness of CNTs within the composites should be minimized. To accomplish this, a simple local heating and stretching method was used to uniformly stretch the nanotubes together with the polymer matrix. Stretching has proven to be effective in previous work [68]. With a low glass transition temperature (45° C.) and large strain-to-failure value, nylon stands out as a suitable matrix for stretching. As opposed to stretching a whole CNT composite sample (which results in inhomogeneous elongation), local heating and stretching (see FIG. 7d) of the composite makes it possible to uniformly stretch a long sample to larger strain, and is thus more efficient in reducing waviness. At temperatures close to the melting point of nylon, the polymer chains are much more mobile and can reconfigure more easily under applied strain, allowing the CNTs to straighten. SEM images indicate that the post-strained CNTs (FIG. 10b) are much straighter and better aligned in the direction of the long axis than those in the as-drawn CNT ribbon (FIG. 10a). Morphologies of CNTs in the composites before and after stretching are shown in FIG. 10c and FIG. 10d, respectively. In the as-drawn CNT ribbon, CNTs are very wavy along the axial direction. Consequently, only a fraction of the CNTs carry longitudinal load. In the stretched sample, the straightened nanotubes bear the load simultaneously, which results in higher mechanical strength of the composites.

High CNT volume fraction (and/or high CNT mass fraction) and good CNT dispersion in the polymer matrix are desirable and both were achieved by diluting the polymer solution. However, as the volume fraction of CNTs increased, the heated stretching became more challenging. Following the stretching step, hot-pressing reduced the thickness of the CNT composites by approximately 20% with a final thickness of 16±1 μm. The CNT mass fraction of the CNT/nylon 6,6 composites was determined using TGA. The differences in the mass losses (TGA curves) of nylon 6,6 and the composite sample were measured and a mass fraction of 20% was estimated. Given the densities of nylon 6,6 and CNTs at 1.14 and 2.1 g/cm³, respectively, the volume fraction of CNTs in the composites was estimated to be 15%.

Typical tensile stress-strain curves for the pristine CNT ribbon, pure nylon 6,6, and CNT/nylon 6,6 composites with increasing stretch ratios are shown in FIG. 11a and FIG. 11b and the results are summarized below in Table 1. The pristine CNT ribbon was densified with ethanol and was wound according to the same method as the CNT composite samples. The dry CNT ribbon exhibited a tensile strength of 90 MPa and a Young's modulus of 3.2 GPa. The tensile strength of as-wound CNT/nylon 6,6 composites was 220 MPa. The strength of the composites with stretch ratios of 2, 4 and 7% were improved to 320, 540 and 630 MPa, respectively, corresponding to 50, 150, and 190% improvement over the respective non-stretched composites. The Young's modulus of CNT/nylon 6,6 composites without stretching was 14 GPa. This was increased to 21, 43 and 56 GPa with the three different stretch ratios, respectively, which correspond to 50, 200, and 290% increase over the respective non-stretched composites. These observations are consistent with other reports in the literature. Bradford et al. [69] used a tensile testing machine to stretch resin infused CNT preforms to a strain of 5% before curing and observed a 33% increase in tensile strength and 50% increase in Young's modulus. The tensile strength and Young's modulus increased with increasing stretching strain. When the composite is stretched, the average space between the nanotubes embedded in the polymer becomes smaller and wavy nanotubes are straightened. Therefore, nanotubes can carry load more efficiently. In the present Example, aligned CNTs were achieved macroscopically through the drawing-winding approach. Further reduction in the microscopic waviness by stretching made the strength enhancement even more significant. Seven percent (7%) stretching of the CNT/nylon 6,6 composites resulted in significant property improvement of the nanotube composites. This is in agreement with the models and simulations on the effect of nanotube waviness [70-73].

TABLE 1
Comparison of the mechanical properties of pristine
CNT ribbons, neat nylon 6,6, and aligned CNT/nylon
6,6 composites with different stretch ratios.

| | Tensile Strength | Young's Modulus | Conductivity |
|---|---|---|---|
| Samples | (MPa) | (GPa) | (S/cm) |
| Pristine CNT | 90 | 3.2 | 520 |
| ribbons | | | |
| Nylon 6,6 neat | 44 | 1.6 | 2.0 × 10⁻¹⁵ |
| 0% S-CNT/nylon | 220 | 14 | 140 |
| 6,6 | | | |
| 2% S-CNT/nylon | 320 | 21 | 190 |
| 6,6 | | | |
| 4% S-CNT/nylon | 540 | 43 | 340 |
| 6,6 | | | |
| 7% S-CNT/nylon | 630 | 56 | 420 |
| 6,6 | | | |

This processing method disclosed in the present Example has produced stronger CNT/nylon composites than those reported in the literature [74-76]. The good mechanical properties of CNT composites in the present Example are rendered by long CNTs, well controlled alignment and reduced waviness. Conventional methods rely on short fiber dispersion, in which inefficient load transfer, misorientation and low volume fraction make it impossible to significantly enhance mechanical properties. In the multi-walled carbon nanotube (MWNT)/nylon composites functionalized with amine groups [77], 1 wt. % of CNTs were incorporated into the matrix by melt compounding, which resulted in limited strength and modulus improvement (up to 59.3 MPa and 3.56 GPa, respectively). Although the CNTs were chemically functionalized with the aim to accomplish good nanotube dispersion and a strong interfacial adhesion with the matrix, the properties of the composites were not improved significantly. Another work [78] on the surface modification of CNTs revealed that only a small degree of functionalization could be applied, otherwise either the damaged surface of CNTs or excessive bonding with the matrix would lead to brittle failure of the materials. Even with moderate surface modification, it is challenging to obtain exceptional mechanical properties due to low CNT volume fraction [79]. The present Example demonstrates that reducing waviness can be an important factor for making strong CNT composites.

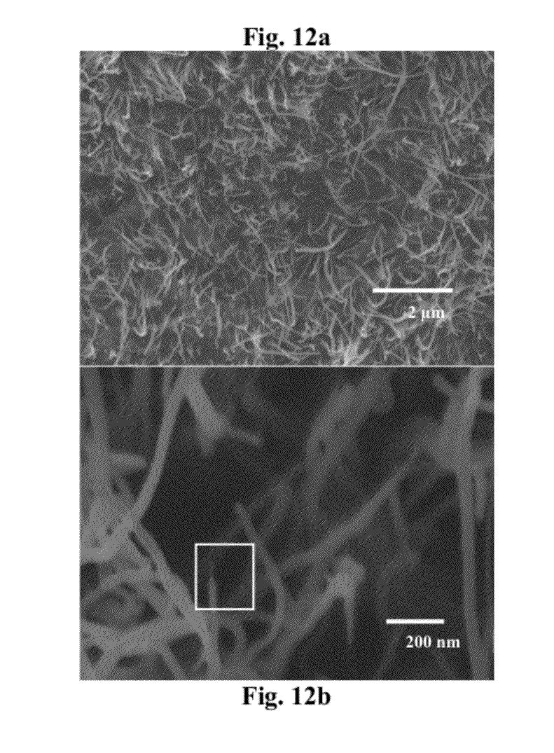

FIG. 12a and FIG. 12b show the fracture surface morphology of a 7% stretched composite sample after tensile testing. Rather than peeling-off of the CNT sheets as reported in CNT buckypaper/BMI composites after stretching [68], FIG. 12a shows individually separated CNTs at the fracture surface. CNTs are also homogeneously distributed throughout the cross-sectional area and the polymer penetrated well between the nanotubes and their bundles. A sheath-core tip is observed on a few CNT ends after failure (FIG. 6b), indicating slippage between the CNT walls. It is believed that stress transfer between walls within MWNTs is low in composites [80]. The nanotubes prepared in this work have an average diameter of 45 nm with approximately 50 walls. There is probably slippage between those walls. Therefore, the stiffness of the composites is lowered. The pull-out length of CNTs was approximately one micrometer. Interfacial shear strength can be further improved, e. g. through enhancement on the bonding between CNTs and the matrix.

Electrical conductivities of the CNT/nylon 6,6 composites are summarized in Table 1 above. Nylon is an insulator and the electrical conductivity of the neat nylon 6,6 is approximately 2.0×10⁻¹⁵ S/cm [81]. The electrical conductivity of pristine CNT sheets and non-stretched composites were 520 S/cm and 140 S/cm, respectively. When the composite was stretched by 7%, the electrical conductivity was increased to 420 S/cm, which is 3 times higher than their non-stretched counterparts. This value is much higher than the electrical conductivity of composites prepared by conventional dispersion methods [82-84]. This is the result of higher CNT volume fraction and enhanced CNT alignment. These results are also consistent with reports on the effect of alignment on electrical conductivities [68, 85, 86].

In the present example, rotational winding and mechanical stretching was used for fabricating CNT/nylon 6,6 composites with good CNT alignment, high CNT volume fraction and straight nanotubes. The rotational winding created aligned CNT composites, while the local heating and stretching led to further reduction of CNT waviness. Both mechanical and electrical properties showed substantial increases (191%, 294% and 207% for tensile strength, Young's Modulus and electrical conductivity, respectively) at the stretch ratio of 7%. Macroscopically aligned CNTs and microscopically reduced waviness were demonstrated as factors that can be important for improving mechanical properties of CNT composites.

### EXAMPLE 3

In the present Example, experimental results are presented that are associated with a method for fabricating high performance CNT composites without the need for functionalization, where the method includes spray-winding (see Example 1) and stretching. In the present Example, CNT-thermosetting polymer composites CNT/BMI composites) were fabricated. Ultra-high aspect ratio CNTs were incorporated into a high volume fraction composite with aligned and straight CNTs and a molecular level of resin integration. These structural features allowed the CNT composites to reach tensile strengths of 3.8 GPa, Young's modulus of 290 GPa, toughness of 30 J/g and electrical conductivity of 1200 S/cm. These mechanical properties may be achieved simultaneously in a CNT composite fabricated according to the present Example. The unprecedented strength exceeds that of current carbon fiber composites and is almost twice as large as previously reported non-functionalized CNT composites. The stretched, wound nanocomposites demonstrated a unique two-phase conductivity behavior under tensile strain, which has never been observed for CNT composites produced by conventional approaches.

Materials and Experimental Procedure

Aligned arrays of multiwalled carbon nanotubes (MWNTs) were grown on a Si wafer with sputtered iron catalyst by a chemical vapor deposition (CVD) method. The CNTs have an outer diameter ranging from 7 nm to 10 nm and have 5 walls. The density of the CNT was thus calculated as 1.46 g/cm³ based on a wall thickness of 0.34 nm and the theoretical density of graphite of 2.26 g/cm³. The arrays covered an area of about 20 cm² and had a height of ˜300 as determined using optical microscopy. The CNTs (i.e., CNT ribbon) were drawn from the arrays and passed through a custom tensioning system, which includes a pair of positioning boards and two cylindrical copper rods (tensioning rods) with outer diameters of 0.5 mm. The CNT ribbon formed from the array and the CNT bundles within the array were highly aligned along the drawing direction. As the CNT ribbon passes around the stationary tensioning rods, the increased tension extends and stretches the CNT bundles. Provided that the uniform geometry of the CNT ribbon was maintained and breaking extension was not reached, the optimal contact angle between the CNT sheet and the stretching tensioning rods was controlled at approximately 150°. The aligned CNT ribbon was then taken up onto a rotating cylindrical polytetrafluoroethylene (PTFE) spool.

The polymer matrix used in the present Example was an imide-extended liquid bismaleimide (BMI, Designer Molecules Inc.) resin with a molecular weight of 5000 and functionality of 2. Dicumyperoxide (Sigma Aldrich) was added to the resin system as the initiator. BMI/toluene solutions (with BMI concentrations of 2.5, 1.0, 0.5 g/L) were agitated using a magnetic stirrer for 1 hour. As the CNT ribbon was wound on the spool, the dilute BMI solution was applied to the CNT ribbon using a fine-line air sprayer. Approximately one thousand winding revolutions at a speed of 1.1 m/min produced a unidirectional CNT/BMI composite prepreg (10 cm long, 0.5 cm wide and 10-15 μm thick). The CNT preform was then removed from the PTFE spool and heated in a vacuum oven at 90° C. for 2 hours. This temperature was found effective to remove the residual solvent but was far enough below the peroxide decomposition temperature to prevent unwanted curing. The uncured preform was then cut into strips as tensile testing coupons, hot-pressed between glass blocks coated with a PTFE release agent and cured in a vacuum oven at 180° C. for 2 hours. Hot-pressing reduced the thickness of the CNT composites by approximately 30% to a final thickness of (7˜10)±1 μm.

CNT alignment in the CNT composite was parallel to the longitudinal direction of the tensile loading. Mechanical property tests were performed using a Shimadzu EZ-S tensile tester with a crosshead speed of 0.5 mm/min and a gauge length of 6 mm at room temperature. Sample width was measured using an optical microscope (30×). The sample thickness was measured using a micrometer and the error was verified to be within 15% using thickness measurements via a scanning electron microcopy (SEM). At least five specimens were tested for each CNT/BMI composite. Resistance was measured using the four-probe method. Transmission electron microscopy (TEM) analysis of the nanotubes was performed using a JEOL 2010F microscope at an acceleration voltage of 200 kV. After tensile tests, SEM analysis of the sheets and composite fracture surface was carried out on a JEOL 6400F microscope with an acceleration voltage of 5 kV. TGA was conducted on a Perkin Elmer Pyris 1 machine in nitrogen (99.999%) with a heating rate of 10° C. per minute. A laser flash method was used to measure the room temperature thermal diffusivity of the composites. One surface of a thin flat composite sample (5 mm×25 mm in size) was exposed to a high-intensity energy pulse using a laser beam. The energy of the beam is absorbed by the sample and the temperature rise is monitored as a function of time using a thermocouple. The thermal diffusivity of the sample is obtained by analyzing the linear zone of both the amplitude decay and the phase shift. Resistance was measured using the four-probe method. In situ strain-conductivity (converted from strain-resistance results) measurement was carried out using a combination of an Agilent 34410A 6.5 digit multimeter and the Shimadzu EZ-S tensile tester. To ensure good electrical contact, both ends of the specimen were coated with copper using a magnetron sputtering facility. The coated parts of the composite specimen were then glued to copper wires using silver filled conductive epoxy. The measured resistance was recorded in situ as the specimen was loaded in tension.

The volume fraction (V_{f}) of CNTs in the CNT composites was calculated to be 46%. It is calculated based on a CNT mass fraction of 50%, a composite density of 1.4 g/cm³ and a resin density of 1.3 g/cm³, according to the following formula:

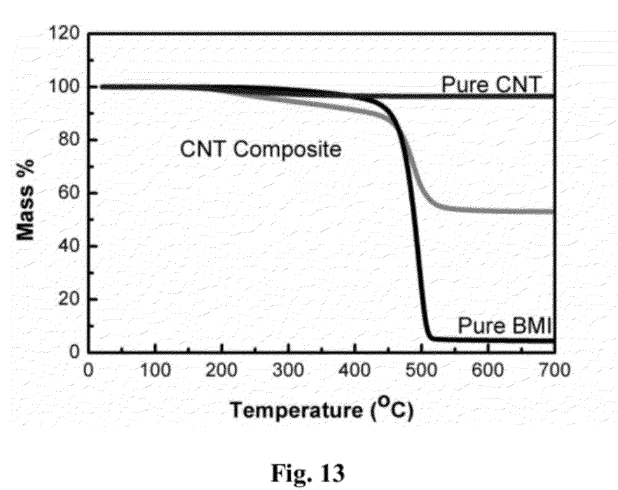

V_{f}=1−((1−m_{f})*ρ_{c})/ρₘ)

where m_{f}, ρ_{c} and ρₘ are the mass fraction of CNTs in the composite, the density of the composite and the density of the polymer matrix, respectively. The mass fraction of CNTs is determined using TGA, by subtracting the baseline CNT and BMI mass fractions from that of the composite (see FIG. 13).

Results and Discussion

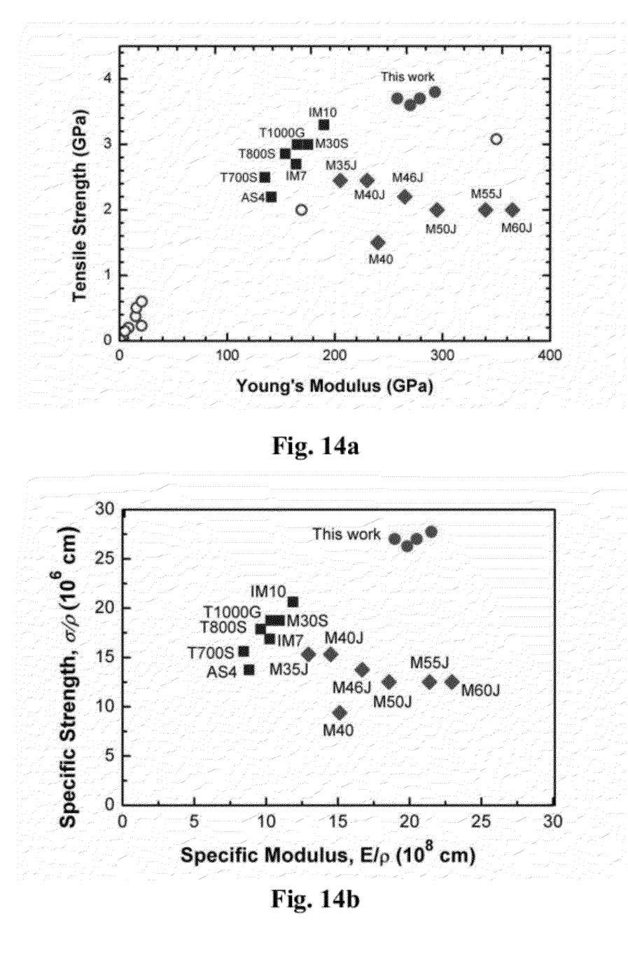

In the present Example, a method is disclosed for facile and scalable synthesis of high volume fraction (46%) CNT composites containing aligned and straight nanotubes. The present Example demonstrates the importance of reducing CNT waviness in CNT composites. As shown in FIG. 14a, the strength and Young's modulus of the CNT composites disclosed in the present example are far larger than values for CNT composites reported previously [87-91]. In FIG. 14a, the blue filled squares are the tensile strengths and Young's moduli of current existing high-strength CFRPs and the green filled diamonds are those of current existing high-modulus CFRPs. The unfilled grey circles are CNT composites reported previously [87-91]. The tensile strength of the strongest CNT composite in the present Example is 15% higher than the strongest commercial CFRP (IM10/epoxy). The Young's Modulus of the strongest CNT composite in the present Example is comparable to that of the commercial high-modulus CFRP. Furthermore, the density of the CNT composite of the present Example is 1.4 g/cm³, while CFRP has a density of ˜1.6 g/cm³ with a typical 60% fiber volume percentage. Therefore, the specific strength (see FIG. 14b) of the CNT composite in the present Example is at least 30% higher than the specific strength of the strongest commercial CFRP (IM10/epoxy).

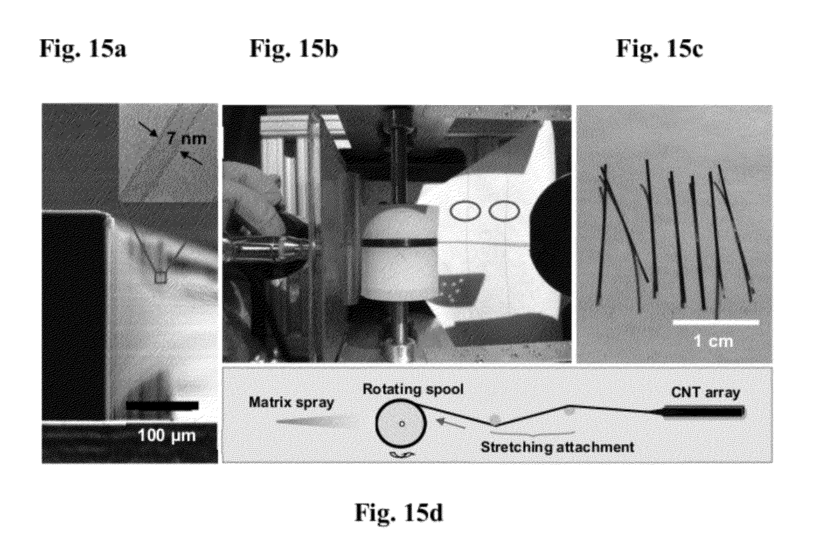

The exceptional properties of the CNT composites in the present Example may be attributed to straightening CNTs before embedding the CNTs into polymer matrix. In the present Example, a vertically aligned CNT array (see FIG. 15a), which was synthesized by a chemical vapor deposition (CVD) method [92], was used as the starting material. The TEM image shows a nanotube having 5 walls and a diameter of 7 nm (see inset in FIG. 15a). A tensioning system was used in the present Example to align and straighten the CNTs (as shown in FIG. 15b). As a CNT ribbon is drawn from the CNT array, individual or CNT bundles are aligned in the drawing direction in the CNT ribbon. However, the CNTs largely possess microscopic waviness. The formed CNT ribbon travels around two cylindrical copper wires (the tensioning rods) which are stationary. This process induces a tension to the CNT sheet following the capstan equation [93]. The increased tension extends and stretches the CNT bundles in the drawing direction. FIG. 15d shows a schematic of the stretch-winding process. The ribbon of straightened CNTs was then taken up onto a rotating cylindrical polytetrafluoroethylene (PTFE) spool. In Example 1, CNT sheets were wound on the mandrel and integrated with polymer using a spray gun. In Example 1, high volume fraction CNT composites were disclosed. However, the air from the sprayer in Example 1 may disrupt the CNT alignment to some degree. In the present Example, aligned CNTs were stretched by the tension system before being taken up on the spool and the straightened structure was retained throughout the composite fabrication process. This modification not only reduced the CNT waviness but also prevented the aligned structure from being disturbed by the air from the matrix sprayer. Thermosetting polymer systems, such as BMI and epoxy resin, have extensive use in the composite industry. High temperature and high performance BMI resin was used as the matrix system in this Example. BMI/toluene solutions with various concentrations were prepared for investigation of composite performance. A sprayer was used to deliver BMI/toluene solution in a layer-by-layer fashion as the CNT ribbon was wound onto the spool. FIG. 15c shows the tensile test strips cut from the resultant composites. In the present Example, we refer to a winding process without stretching as R-winding and a winding process with stretching as S-winding. Wound CNT composites that have not been stretched may be referred to as as R-wound composites and wound CNT composites that have been stretched may be referred to as S-wound composites.

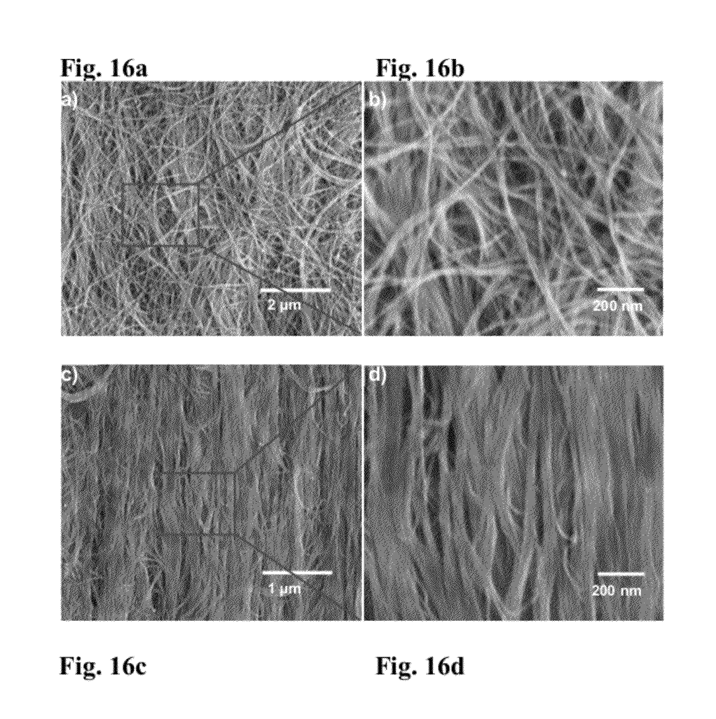

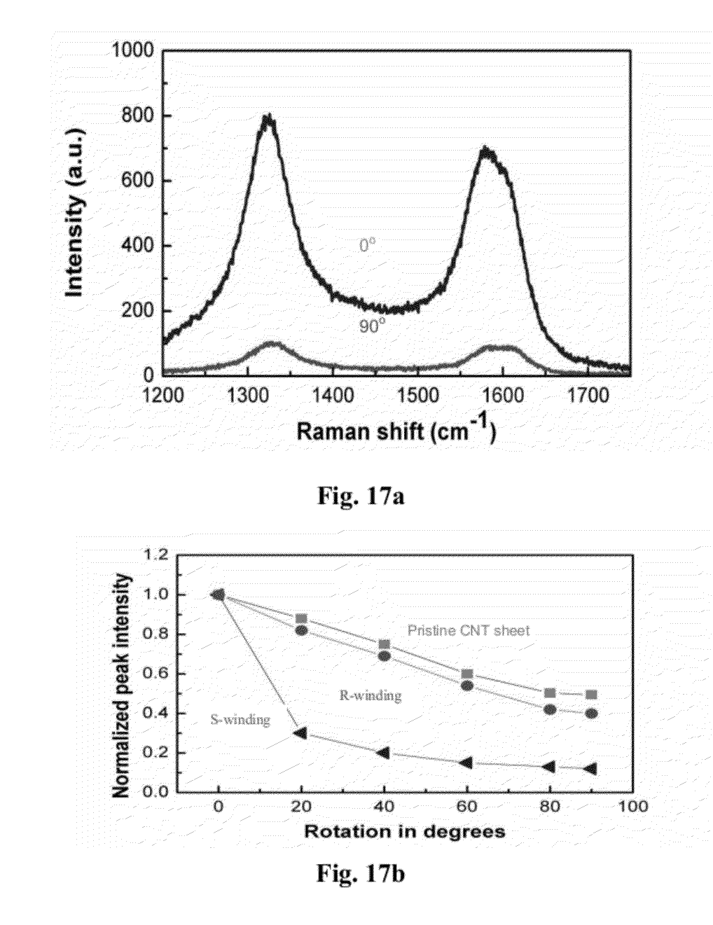

Nanocomposites fabricated according to the rapid S-winding approach contain more straight CNTs than nanocomposites fabricated according to the R-winding approach. FIGS. 16a-16d illustrate the difference in nanotube structures between R-wound and S-wound composites. When the CNTs were wound without stretching, individual nanotubes followed tortuous paths with only a limited orientation factor (FIG. 16a). Although produced from an array of aligned CNTs, alignment was largely decreased through processing. Voids are present in the CNT webs (FIG. 16b). In comparison, composites that were stretched according to the present Example contained more aligned and straightened CNTs (FIG. 16c). As a result, the number of voids was minimized and more intimate contact between the nanotubes was created (FIG. 16d). To further investigate the alignment of CNTs, polarized Raman spectroscopy was utilized to measure the shift of the ratio R of intensity of G band peaks (R=I_{G∥}/I_{G⊥}). The G-band Raman intensity is at its maximum when the polarization is parallel to the aligned axis (θ=0) and its minimum when the polarization is perpendicular (θ=90) (FIG. 17a). The intensity ratio R of pristine CNT sheets with ethanol densification is 2. The CNTs in pristine sheets are non-straight and lack intertube connection. For R-wound composites, the ratio R increased to 2.3, indicating that the CNT alignment was improved, which could be attributed to the enhanced tube-tube connection via the polymer matrix which retains the alignment after the solvent evaporation. As the nanotubes were stretched and integrated with polymer, R increased dramatically up to 7.6 (FIG. 17b), showing that stretching imparted a significant alignment factor to the material.

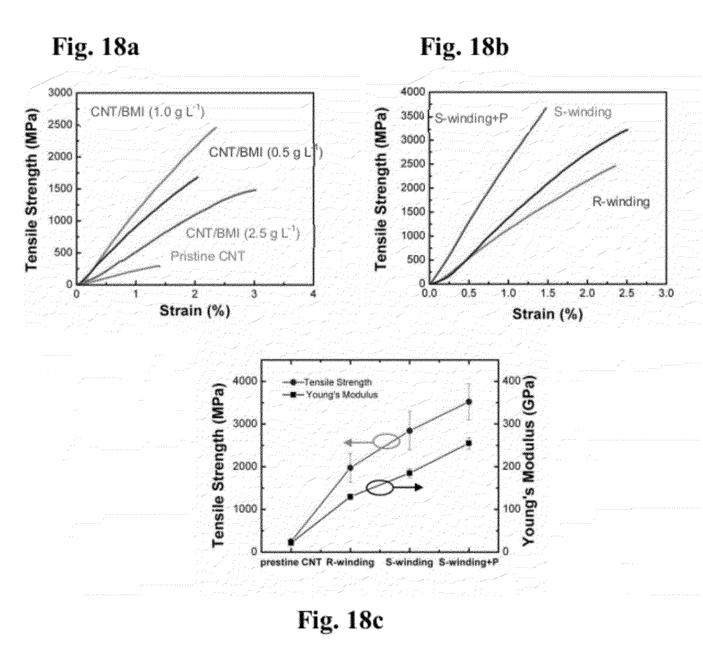

With the structure improvement discussed above, the S-wound composites achieved much higher strength and stiffness than R-wound composites. Three BMI resin solution concentrations were used to maximize the CNT volume fraction, while minimizing voids. BMI solutions with concentrations of 2.5, 1.0 and 0.5 g/L were used to fabricate the composites. As shown in FIG. 18a, the strength of pristine CNT sheets was 300 MPa. As the resin concentration was decreased from 2.5 g/L to 1.0 g/L, the strength increased from 1.4 GPa to 2.0 GPa, respectively. As the concentration was further decreased to 0.5 g/L, the mechanical properties did not improve. This is because with such a limited matrix, CNTs or their bundles are less likely to be penetrated well. The CNTs weak interactions with polymer in turn lead to inefficient load transfer. As compared to the pristine aligned CNT sheets, both the strength and stiffness of the CNT/BMI composites increased with the decrease of matrix concentration until reaching the optimal BMI concentration of 1.0 g/L. This trend was also reported for R-winding of CNT/PVA composites in Example 1. After the nanotubes were stretched (FIG. 18b) so that a larger amount of straight CNTs were taking the load simultaneously, the mechanical properties of the resultant composites were further improved, which are an order of magnitude higher in both strength and Young's Modulus as compared to pristine CNT sheets (see Table 2 below). As shown in FIG. 18c, for S-wound composites with post-straining (S-wound+P) the average tensile strength and Young's Modulus reached 3500 MPa and 270 GPa, respectively, which is a respective 78% and 108% improvement over R-wound composites. The highest tensile strength and Young's Modulus data points for the S-wound CNT/BMI composites with post-straining were 3800 MPa and 290 GPa, respectively. The toughness of the nanocomposites was calculated from the area under the stress-strain curves. Toughness reached (22±5) J/g, which is comparable to toughened CFRP, and higher than the recently reported high-strength CNT/BMI nanocomposites (<15 J/g) [94,95]. The toughness of the S-wound composites increases composite structure safety by preventing catastrophic failure.

TABLE 2
The tensile strength, Young's modulus (stiffness), strain to failure
values and toughness of the S-wound composites with post-straining.

| | Strength | Stiffness | Strain-to-Failure | Toughness |
|---|---|---|---|---|
| Sample | (GPa) | (GPa) | (%) | (J/g) |
| 1 | 3.7 | 279 | 1.2 | 18 |
| 2 | 3.0 | 216 | 1.8 | 22 |
| 3 | 3.8 | 293 | 1.3 | 20 |
| 4 | 3.7 | 258 | 1.5 | 23 |
| 5 | 3.6 | 270 | 1.6 | 30 |
| 6 | 3.1 | 280 | 1.3 | 16 |
| Average | 3.5 | 266 | 1.5 | 22 |

The scatter of the data may be caused by test specimen preparation or various processing parameters for the composites.

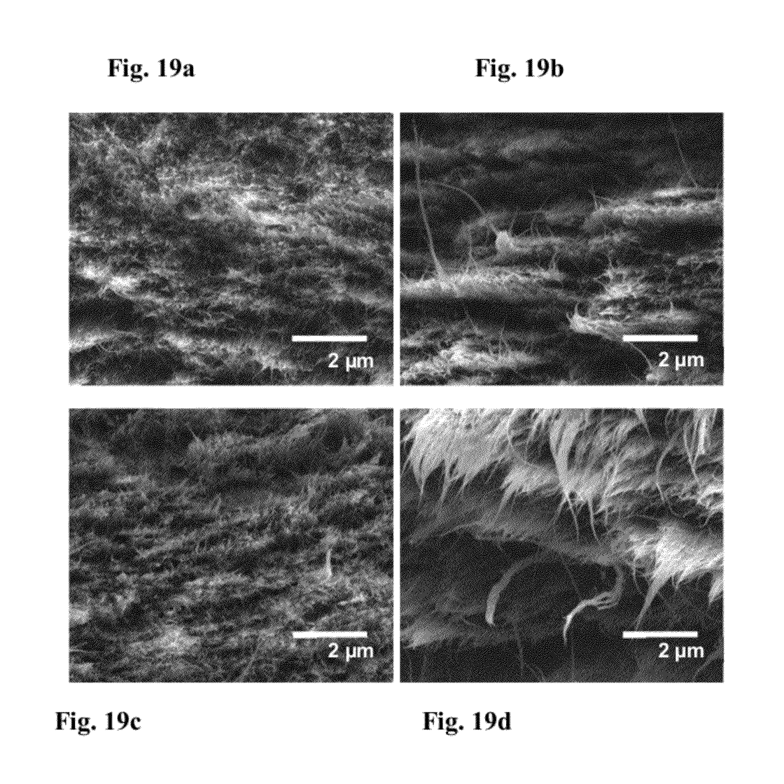

Scanning electron microscopy (SEM) micrographs (FIGS. 19a-19d) reveal the fracture morphology and matrix penetration of R-wound and S-wound composites. FIGS. 19a to 19c show the fracture surfaces of R-wound composites with BMI concentrations of 2.5, 1.0 and 0.5 g/L, respectively. Excessive polymer resulted in composites with low CNT volume fraction and insufficient polymer resulted in poor matrix bonding with CNTs. Therefore, composites with BMI concentrations of 2.5 and 0.5 g/L demonstrated both low strength and stiffness. High volume fraction, good matrix penetration, and a layered failure mode for R-wound composites fabricated with BMI solution concentration of 1.0 g/L were observed. The layered failure mode may be due to the effective load transfer between CNTs and the matrix. It is also may be due to the spray method since one layer may dry before the next is sprayed on, thus allowing for polymer migration between layers. FIG. 19d is a SEM micrograph of a fractured S-wound composite. The CNTs with stretch deformation are largely assembled along the loading direction. Similarly, the S-wound composite presented a layered failure mode. Under tensile loading, a large fraction of straightened CNTs may simultaneously be taking load. These CNT composites realized good load transfer with the polymer matrix, which resulted in high strength and good toughness.

The room temperature thermal properties of CNT/BMI composites with different levels of CNT alignment are presented in Table 3 below. The in-plane thermal diffusivities of the CNT composites, α, were measured using a scanning laser heating analyzer (Ulvac-Riko, Inc., Laser PIT). The thermal conductivities of the composites, λ, were calculated using λ=αρC, where ρ is the density and C is the specific heat of the composite. It was observed that the thermal conductivities of S-wound composites are 2.5 times larger than those of R-wound composites. The S-wound composite with post straining has the highest thermal conductivity among the tested materials, 37 W/m*K, which is higher than that of unidirectional CFRP [105] and other reported CNT composites [102]. This indicates that stretching improves the alignment and straightness of CNTs and promotes a more efficient conducting path for the heat carrying wave packages (phonons). Additionally, the non-functionalized CNTs with intact structures that were used in this Example would be less likely to scatter phonons than the functionalized ones. However, the phonon mismatch at interfaces of the nanotube and matrix could result in high thermal interface resistance (Kapitza resistance). Therefore, the thermal conductivity of these composites is not as pronounced as that calculated by the rule of mixture [106].

TABLE 3
In-plane thermal diffusivity and thermal conductivity data
for CNT/BMI composites with different alignment levels.

| | Thermal diffusivity | Thermal conductivity |
|---|---|---|
| | (m²/s) | (W/m · K) |
| R-wound | 1.0 × 10⁻⁵ | 13 |
| S-wound | 2.5 × 10⁻⁵ | 33 |
| S-wound + P | 2.7 × 10⁻⁵ | 37 |

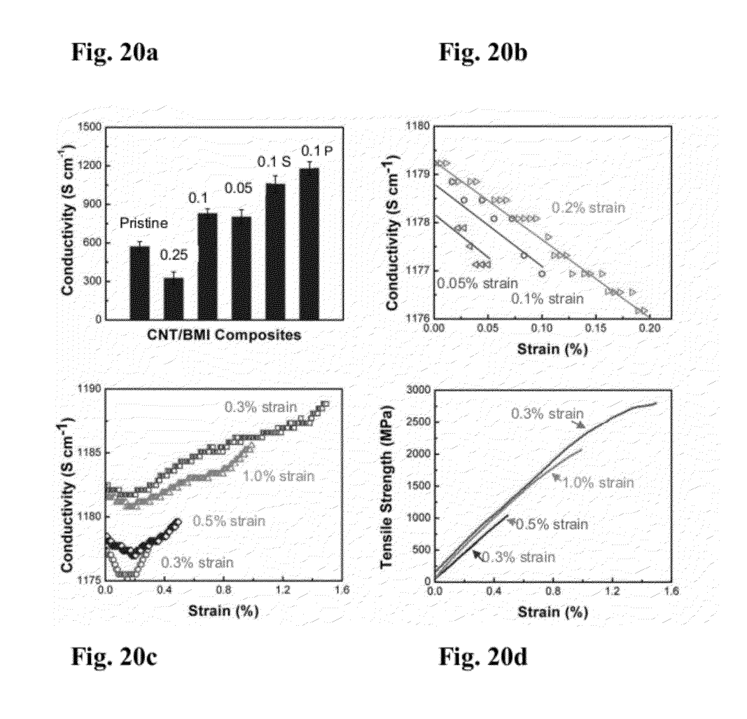

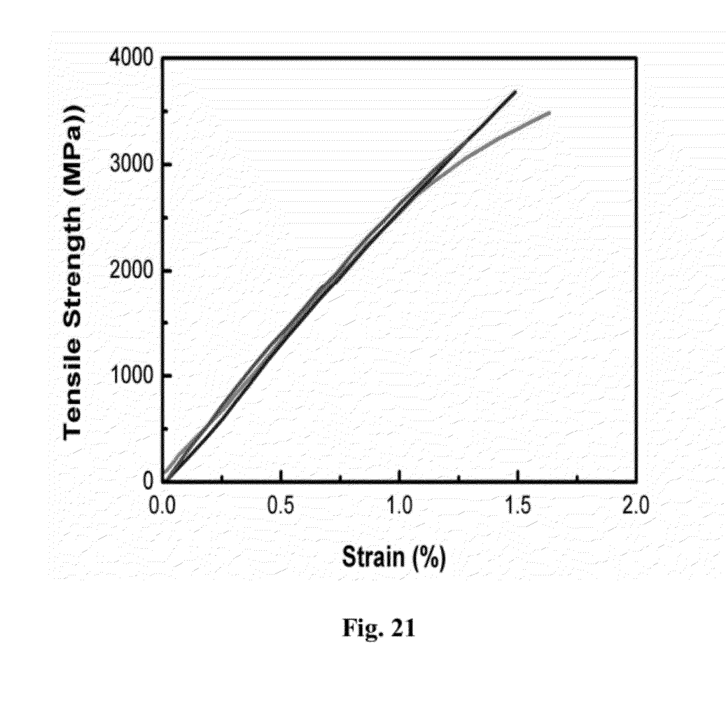

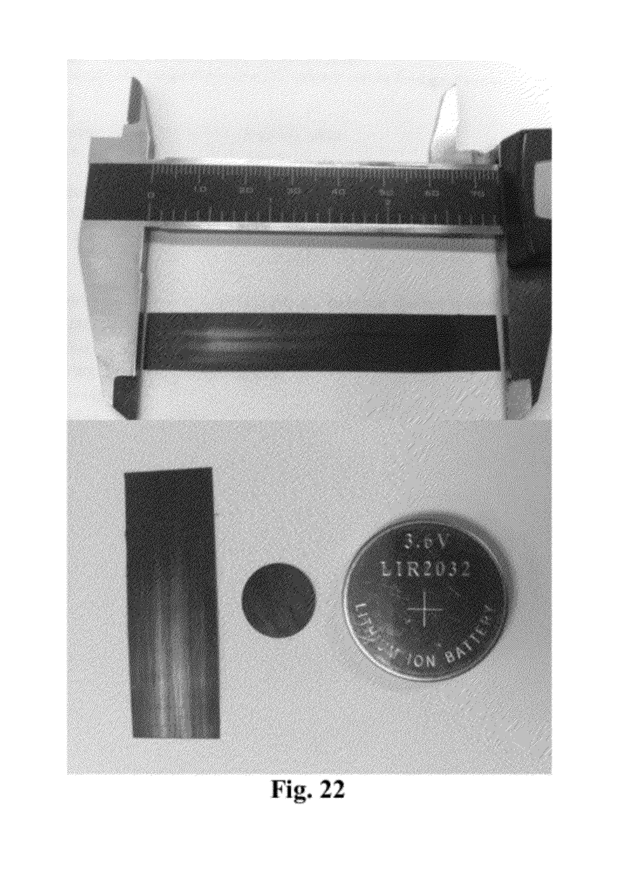

In addition to the increase in strength, stiffness, and thermal conductivity as the nanotubes are straightened, the resultant composites reveal excellent electrical conductivities because the unidirectional pathway of electron transfer is facilitated by the improved CNT alignment and reduced waviness. Electrical conductivities by four-point measurement for the pristine CNT ribbons and resultant CNT composites are shown in FIG. 20a. The pristine CNT ribbons, which were shrunk with ethanol, present a decent conductivity of 570 S/cm due to the ordered and aligned structure. When a relatively high concentration BMI solution (2.5 g/L) is introduced, CNTs or their bundles are wrapped with polymer layers. Therefore, the electrical conductivity of the composite decreases as the intertube contact is degraded. However, when the matrix concentration decreases, for composites fabricated with 1.0 g/L BMI solution, the electrical conductivity increases to 820 S/cm. This value is larger than that obtained for pristine CNT sheets. The increase in electrical conductivity may be due to the capillary force of dilute BMI solution which draws the CNTs closer to each other. A thin layer of cross-linked BMI ensures good intertube contact after the large amount of solvent is evaporated. Composites made with 0.5 g/L BMI solution did not exhibit higher conductivity than that made with 1.0 g/L solution, which could be due to the debonding of CNT bundles as a result of insufficient polymer. With the BMI solution of 1.0 g/L, the conductivity of resultant composites increases monotonically with increasing alignment of the CNTs. S-wound composites with post-straining have the highest level of alignment and straightness among all the samples and thus, a highest conductivity of 1230 S/cm, which is a 116% increase over the pristine CNT sheets.

The electrical conductivity of the S-wound CNT composites was also measured in situ during the tensile testing as a function of elastic strain. The conductivity of the composites decreases proportionally with increasing tensile strain from 0 to 0.2% (as shown in FIG. 20b). After a threshold tensile strain of 0.2%, the samples demonstrate a definitive trend where the conductivity increases as they are strained up to 0.3, 0.5, 1.0 and 1.5% (as shown in FIG. 20c), indicating a different mechanism from the mechanism that applies to small tensile strains. This may be explained by noting that individual nanotubes in the composite are elongated under small tensile strains (e.g., 0˜0.2%). Hence, the band gap of these individual CNTs increases, which leads to a collective conductivity decrease across the composite, as modeled by Minot et al. [96]. However, at larger tensile strains (e.g., 0.3˜1.5%), straining of individual CNTs is no longer a dominant factor for the conductivity change as the CNTs are realigned and the reinforcement network is reconfigured. As the composites undergo larger strains the CNTs are further straightened, making them more conductive, as demonstrated similarly in several studies of carbon fiber-polymer composites [97-98]. This explanation is supported by the increase in starting point of electrical conductivity (FIG. 20c) and the increase in Young's Modulus of the composites (FIG. 20d) as they were strained repeatedly from 0.3% to 1.5%.

It may be tempting to assign the observed conductivity increase solely to the improvement of CNT alignment during the tensile loading. However, a closer look suggests a more complicated mechanism. When the same in-situ test was carried out for R-wound composites, we did not observe such two-phase behavior. The electrical conductivity of the R-wound composites decreased monotonically as the tensile strain increased up to 1.5%, similar to those reported in the literature [99]. In R-wound composites, CNTs are mostly aligned in the drawing direction. Improvement in straightening the CNTs under tensile strain should also produce a conductivity increase instead of the conductivity reduction that was observed in the present Example. To explain the distinct responses for the two types of composites, two possible contradictory factors may be considered that affect the conductivity change of the composites. One factor may be improved contact between CNTs and their neighbors due to contracting forces under tensile strain, and the other factor may be loss of contact and widening of intertube distances. S-wound composites contain straighter CNTs and fewer network joints. Thus, it is reasonable to infer that the effect of contact loss may be dwarfed by the CNT realignment and increased contact length between CNTs due to Poisson's effect. On the contrary, conductivity of R-wound composites is dictated by the number of contact points and distance between neighboring wavy CNTs. Any effect of realignment and contact improvement would yield to the effect of tensile-strain-induced disruption of the conductive network. Therefore, the distinct electrical conductivity behaviors of S-wound and R-wound composites may be the result of this comprehensive effect. Buldum [100] also pointed out that factors such as contact length and surface, or alignment of the atoms at the interface can dramatically alter the contact resistance between CNTs.

Finally, it is important to note the use of non-functionalized CNTs in this work. Functionalization of CNTs has been considered unavoidable for achieving high strength CNT nanocomposites. Interfacial shear strength between the CNTs and the polymer matrix can be improved through the functionalization of CNTs [101-103]. However, the near-perfect structures of nanotubes make the process challenging, as nanotubes are chemically inert and there are hardly any defects for anchoring a pendent group [104]. Functionalization usually creates defects in the nanotube lattice, which compromises their mechanical properties as the CNTs are incorporated into polymer matrices. Non-functionalized CNTs were utilized in this Example to produce high performance nanocomposites. The dilute BMI solution delivered by the sprayer penetrates into each layer of the CNT sheet (as confirmed by SEM micrographs in FIGS. 19a-19d). In the present Example, CNTs or their bundles may be wrapped around by cross-linked BMI resin. Therefore, on one hand, the interaction at the molecular level ensures load to be efficiently transferred. On the other hand, moderate bonding may help with the partial slippage of straight nanotubes and then the simultaneous breakage of a large fraction of nanotubes. This could be another reason for the relatively large strain-to-failure value (1.5%) of the nanocomposites in this Example as compared to the recently reported functionalized high strength CNT nanocomposites (<1.0%) [95].

In summary, in the present Example, CNT thermoset nanocomposites were produced with high strength, stiffness, toughness and electrical conductivity, as well as good thermal conductivity, without the functionalization of CNTs. The exceptional properties are derived from four morphological features: long CNTs, superior alignment and straightness of CNTs, integration of CNTs and polymer matrix at the molecular level, and high CNT volume fraction. The strength of these CNT composites has exceeded the properties of commercially available engineering fiber composites and is much higher than CNT composites reported elsewhere. A unique two-phase conductivity behavior was also observed in the CNT composites. These results provide a route for developing next-generation ultrastrong and multifunctional composite materials.

Additional Implementations

Additional implementations provided in accordance with the presently disclosed subject matter include, but are not limited to, the following:

1. A method for fabricating a carbon nanotube (CNT) composite, the method comprising:

providing an array of CNTs that are substantially aligned in a single direction;

pulling a CNT ribbon from the array by attaching the CNT ribbon to a rotating mandrel and winding the CNT ribbon on the mandrel as the mandrel rotates; and

applying a polymer solution to the CNT ribbon as the CNT ribbon is pulled from the array and wound on the mandrel to form a CNT composite laminate, wherein the polymer solution comprises a polymer and a solvent.

2. The method of implementation 1, wherein applying the polymer solution to the CNT ribbon comprises spraying the polymer solution on the CNT ribbon.

3. The method of implementation 2, wherein the polymer solution is sprayed with a compressed air sprayer.

4. The method of implementation 3, wherein the polymer solution is sprayed through an opening in a screen, wherein the screen is positioned between the mandrel and a nozzle of the sprayer.

5. The method of any of implementations 1-4, wherein the CNT ribbon is pulled from the array at a rate ranging from about 0.018 m/s to about 10 m/s.

6. The method of any of implementations 1-5, wherein the CNTs comprise multi-walled CNTs.

7. The method of any of implementations 1-5, wherein the CNTs comprise single-walled CNTs.

8. The method of any of implementations 1-7, further comprising causing the mandrel to oscillate along a horizontal axis to obtain a predetermined width associated with the CNT composite laminate.

9. The method of any of implementations 1-7, further comprising causing the CNT array to oscillate along a horizontal axis to obtain a predetermined width associated with the CNT composite laminate.

10. The method of any of implementations 1-9, further comprising removing the CNT composite laminate from the mandrel.

11. The method of implementation 10, further comprising heating the CNT composite laminate.

12. The method of implementation 11, wherein the CNT composite laminate is heated in a hot press or autoclave.

13. The method of implementation 11, wherein the CNT composite laminate is heated by a local heating source.

14. The method of implementation 13, wherein the local heating source comprises a movable heating element.

15. The method of implementation 11, wherein the polymer is a thermosetting polymer, and wherein the CNT composite laminate is heated to a temperature that is below the curing temperature of the thermosetting polymer.

16. The method of implementation 15, wherein the CNT composite laminate is heated to a temperature up to about 450° C.

17. The method of implementation 11, wherein the polymer is a thermoplastic polymer, and wherein the CNT composite laminate is heated to a temperature that is above the glass transition temperature of the thermoplastic polymer and below the melting point of the thermoplastic polymer.

18. The method of implementation 17, wherein the CNT composite laminate is heated to a temperature up to about 180° C.

19. The method of implementation 11, further comprising stretching the CNT composite laminate.

20. The method of implementation 19, wherein stretching the CNT composite laminate is carried out according to a stretch ratio ranging from greater than 0% to about 100%.

21. The method of implementation 20, wherein stretching the CNT composite laminate is carried out according to a stretch ratio ranging from greater than 0% to about 10%.

22. The method of implementation 11, further comprising stretching the CNT ribbon prior to applying the polymer solution to the CNT ribbon.

23. The method of implementation 22, wherein stretching the CNT ribbon comprises pulling the CNT ribbon into contact with at least one tensioning rod.

24. The method of any of implementations 1-23, wherein the concentration of the polymer in the polymer solution ranges from greater than 0 g/L to about 500 g/L.

25. The method of implementation 24, wherein the concentration of the polymer in the polymer solution ranges from greater than 0 g/L to about 10 g/L.

26. The method of implementation 25, wherein the concentration of the polymer in the polymer solution ranges from 0.5 g/L to about 2.5 g/L.

27. The method of any of implementations 1-26, wherein the polymer solution comprises up to about 50% polymer by weight.

28. The method of any of implementations 1-27, further comprising stretching the CNT ribbon prior to applying the polymer solution to the CNT ribbon.

29. The method of implementation 28, wherein stretching the CNT ribbon comprises pulling the CNT ribbon into contact with at least one tensioning rod.

30. The method of implementation 28, further comprising heating the CNT ribbon prior to applying the polymer solution to the CNT ribbon.

31. The method of implementation 30, wherein the CNT ribbon is heated by a local heating source.

32. The method of implementation 31, wherein the local heating source is movable along the length of the CNT ribbon.

33. The method of any of implementations 1-32, wherein the polymer is a thermosetting polymer.

34. The method of any of implementations 1-32, wherein the polymer is a thermoplastic polymer.

35. A CNT composite comprising a polymer integrated with a plurality of long, substantially straight CNTs that are highly aligned in a single direction;

wherein the CNT composite has a Young's modulus ranging from about 14 GPa to about 500 GPa; and

wherein the CNT composite has a tensile strength ranging from about 0.22 GPa to about 10 GPa.

36. The CNT composite of implementation 35, wherein the thermal conductivity ranges from about 10 W*m⁻¹K⁻¹ to about 200 W*m⁻¹K⁻¹.

37. The CNT composite of implementation 35 or 36, wherein the polymer comprises a thermosetting polymer.

38. The CNT composite of implementation 37, wherein the CNT composite has a toughness ranging from about 16 J/g to about 46 J/g.

39. The CNT composite of implementation 37, wherein the CNT composite has an electrical conductivity ranging from about 820 S/cm to about 1230 S/cm.

40. CNT composite of implementation 37, wherein the tensile strength ranges from about 1.4 GPa to about 10 GPa.

41. CNT composite of implementation 37, wherein the Young's modulus ranges from about 216 GPa to about 500 GPa.

42. CNT composite of implementation 37, wherein the CNT composite has a CNT volume fraction ranging from about 46% to about 60%.

43. CNT composite of implementation 37, wherein the CNT composite has a CNT mass fraction of about 50%.

44. The CNT composite of implementation 35 or 36, wherein the polymer comprises a thermoplastic polymer.

45. The CNT composite of implementation 44, wherein the tensile strength ranges from about 1.3 GPa to about 2.0 GPa.

46. The CNT composite of implementation 44, wherein the CNT composite has a toughness ranging from about 65 J/g to about 112 J/g.

47. The CNT composite of implementation 44, wherein the CNT composite has an electrical conductivity ranging from about 140 S/cm to about 781 S/cm.

48. The CNT composite of implementation 47, wherein the electrical conductivity ranges from about 520 S/cm to about 781 S/cm.

49. CNT composite of implementation 44, wherein the tensile strength ranges from about 0.22 GPa to about 2.0 GPa.

50. CNT composite of implementation 44, wherein the Young's modulus ranges from about 14 GPa to about 100 GPa.

51. CNT composite of implementation 44, wherein the CNT composite has a CNT mass fraction ranging from about 28% to about 78%.

52. The CNT composite of any of implementations 35-51, wherein the CNTs comprise multi-walled CNTs.

53. The CNT composite of any of implementations 35-51, wherein the CNTs comprise single-walled CNTs.

### REFERENCES

The following references are incorporated in their entireties by reference herein:
[1] M. F. Yu, B. S. Files, S. Arepalli, R. S. Ruoff, Phys. Rev. Lett. 2000, 84, 5552.
[2] X. L. Wei, Q. Chen, L. M. Peng, R. L. Cui, Y. Li, J. Phys. Chem. C. 2009, 113, 17002.
[3] E. T. Thostenson, Z. Ren, T.-W. Chou, Compos. Sci. Technol. 2001, 61, 1899.
[4] J. N. Coleman, U. Khan, W. J. Blau, Y. K. Gun'ko, Carbon. 2006, 44, 1624.
[5] T. W. Chou, L. M. Gao, E. T. Thostenson, Z. G. Zhang, J. H. Byun, Compos. Sci. Technol. 2010, 70, 1.
[6] K. Q. Xiao, L. C. Zhang, J. Mater. Sci. 2005, 40, 6513.
[7] J. N. Coleman, U. Khan, Y. K. Gun'ko, Adv. Mater. 2006, 18, 689.
[8] M. T. Byrne, Y. K. Gun'ko, Adv. Mater. 2010, 22, 1672.
[9] U. K. Vaidya, K. K. Chawla, Int. Mater. Rev. 2008, 53, 185.
[10]Q. F. Cheng, J. P. Wang, J. J. Wen, C. H. Liu, K. L. Jiang, Q. Q. Li, S. S. Fan, Carbon 2010, 48, 260.
[11]Q. F. Cheng, J. P. Wang, K. L. Jiang, Q. Q. Li, S. S. Fan, J. Mater. Res. 2008, 23, 2975.
[12]P. D. Bradford, X. Wang, H. Zhao, J.-P. Maria, Q. X. Jia, Y. T. Zhu, Compos. Sci. Technol. 2010, 70, 1980.
[13]Q. F. Cheng, J. W. Bao, J. Park, Z. Y. Liang, C. Zhang, B. Wang, Adv. Funct. Mater. 2009, 19, 3219.
[14]Q. F. Cheng, B. Wang, C. Zhang, Z. Y. Liang, Small 2010, 6, 763.
[15]M. S. P. Shaffer, A. H. Windle, Adv. Mater 1999, 11, 937.
[16]Z. Jin, K. P. Pramoda, G. Xu, S. H. Goh, Chem. Phys. Lett. 2001, 337, 43.
[17]P. Potschke, T. D. Fornes, D. R. Paul, Polymer 2002, 43, 3247.
[18]R. R. Nayak, K. Y. Lee, A. M. Shanrnugharaj, S. H. Ryu, Eur. Polym. J. 2007, 43, 4916.
[19]Z. J. Jia, Z. Y. Wang, C. L. Xu, J. Liang, B. Q. Wei, D. H. Wu, S. W. Zhu, Mater. Sci. Eng. A-Struct. Mater. Prop. Microstruct. Process. 1999, 271, 395.
[20]W. K. Maser, A. M. Benito, M. A. Callejas, T. Seeger, M. T. Martinez, J. Schreiber, J. Muszynski, O. Chauvet, Z. Osvath, A. A. Koos, L. P. Biro, Mater. Sci. Eng. C-Biomimetic Supramol. Syst. 2003, 23, 87.
[21]S. J. Park, M. S. Cho, S. T. Lim, H. J. Choi, M. S. Jhon, Macromol. Rapid Commun. 2003, 24, 1070.
[22]L. Jin, C. Bower, O. Zhou, Appl. Phys. Lett. 1998, 73, 1197.
[23]S. N. Li, B. Li, Z. M. Li, Q. Fu, K. Z. Shen, Polymer. 2006, 47, 4497.
[24]K. Iakoubovskii, Cent. Eur. J. Phys. 2009, 7, 645.
[25]Z. Wang, P. Ciselli, T. Peijs, Nanotechnology 2007, 18.
[26]A. A. Mamedov, N. A. Kotov, M. Prato, D. M. Guldi, J. P. Wicksted, A. Hirsch, Nat. Mater. 2002, 1, 190.
[27]M. Olek, J. Ostrander, S. Jurga, H. Mohwald, N. Kotov, K. Kempa, M. Giersig, Nano Lett. 2004, 4, 1889.
[28]Y. Tian, J. G Park, Q. Cheng, Z. Liang, C. Zhang, B. Wang, Nanotechnology 2009, 20, 335601.
[29]B. S. Shim, J. Zhu, E. Jan, K. Critchley, S. S. Ho, P. Podsiadlo, K. Sun, N. A. Kotov, ACS Nano. 2009, 3, 1711.
[30]Jia, Z. J.; Wang, Z. Y.; Xu, C. L.; Liang, J.; Wei, B. Q.; Wu, D. H.; Zhu, S. W. Study on poly(methyl methacrylate)/carbon nanotube composites. Mater Sci. Eng., A 1999, 1-2, 395-400.
[31]Gong, X. Y.; Liu, J.; Baskaran, S.; Voise, R. D.; Young, J. S. Surfactant-assisted processing of carbon nanotube/polymer composites. Chem. Mater 2000, 4, 1049-1052.
[32]Moniruzzaman, M.; Winey, K. I. Polymer nanocomposites containing carbon nanotubes. Macromolecules 2006, 16, 5194-5205.
[33]Rosca, I. D.; Watari, F.; Uo, M.; Akaska, T. Oxidation of multiwalled carbon nanotubes by nitric acid. Carbon 2005, 15, 3124-3131.
[34]Simmons, T. J.; Bult, J.; Hashim, D. P.; Linhardt, R. J.; Ajayan, P. M. Noncovalent functionalization as an alternative to oxidative acid treatment of single wall carbon nanotubes with applications for polymer composites. Acs Nano 2009, 4, 865-870.
[35]Bogdanovich, A. E.; Bradford, P. D. Carbon nanotube yarn and 3-D braid composites. part I: Tensile testing and mechanical properties analysis. Composites Part A 2010, 2, 230-237.
[36]Bradford, P. D.; Bogdanovich, A. E. Carbon nanotube yarn and 3-D braid composites. part II: Dynamic mechanical analysis. Composites Part A 2010, 2, 238-246.
[37]Mora, R. J.; Vilatela, J. J.; Windle, A. H. Properties of composites of carbon nanotube fibres. Compos. Sci. Technol. 2009, 10, 1558-1563.
[38]Vigolo, B.; Poulin, P.; Lucas, M.; Launois, P.; Bernier, P. Improved structure and properties of single-wall carbon nanotube spun fibers. Appl. Phys. Lett. 2002, 7, 1210-1212.
[39]Ericson, L. M.; Fan, H.; Peng, H. Q.; Davis, V. A.; Zhou, W.; Sulpizio, J.; Wang, Y. H.; Booker, R.; Vavro, J.; Guthy, C.; Parra-Vasquez, A. N. G; Kim, M. J.; Ramesh, S.; Saini, R. K.; Kittrell, C.; Lavin, G; Schmidt, H.; Adams, W. W.; Billups, W. E.; Pasquali, M.; Hwang, W. F.; Hauge, R. H.; Fischer, J. E.; Smalley, R. E. Macroscopic, neat, single-walled carbon nanotube fibers. Science 2004, 5689, 1447-1450.
[40]Ci, L.; Suhr, J.; Pushparaj, V.; Zhang, X.; Ajayan, P. M. Continuous carbon nanotube reinforced composites. Nano Lett. 2008, 9, 2762-2766.
[41]Zhang, X. F.; Li, Q.; Holesinger, T. G; Arendt, P. N.; Huang, J. Y.; Kirven, P. D.; Clapp, T. G; DePaula, R. F.; Liao, X. Z.; Zhao, Y. H.; Zheng, L. X.; Peterson, D. E.; Zhu, Y. T. Ultrastrong, stiff, and lightweight carbon-nanotube fibers. Adv. Mater. 2007, 23, 4198-4201.
[42]Behabtu, N.; Green, M. J.; Pasquali, M. Carbon nanotube-based neat fibers. Nano Today 2008, 5-6, 24-34.
[43]Kumar, S.; Dang, T. D.; Arnold, F. E.; Bhattacharyya, A. R.; Min, B. G; Zhang, X. F.; Vaia, R. A.; Park, C.; Adams, W. W.; Hauge, R. H.; Smalley, R. E.; Ramesh, S.; Willis, P. A. Synthesis, structure, and properties of PBO/SWNT composites. Macromolecules 2002, 24, 9039-9043.
[44]Jiang, K. L.; Li, Q. Q.; Fan, S. S. Nanotechnology: Spinning continuous carbon nanotube yarns—carbon nanotubes weave their way into a range of imaginative macroscopic applications. Nature 2002, 6909, 801-801.
[45]Zhang, M.; Atkinson, K. R.; Baughman, R. H. Multifunctional carbon nanotube yarns by downsizing an ancient technology. Science 2004, 5700, 1358-1361.
[46]Zhang, X.; Jiang, K. L.; Feng, C.; Liu, P.; Zhang, L.; Kong, J.; Zhang, T. H.; Li, Q. Q.; Fan, S. S. Spinning and processing continuous yarns from 4-InchWafer scale super-aligned carbon nanotube arrays. Adv. Mater. 2006, 12, 1505-1510.
[47]Li, Q. W.; Zhang, X. F.; DePaula, R. F.; Zheng, L. X.; Zhao, Y. H.; Stan, L.; Holesinger, T. G; Arendt, P. N.; Peterson, D. E.; Zhu, Y. T. Sustained growth of ultralong carbon nanotube arrays for fiber spinning Adv. Mater. 2006, 23, 3160-3163.
[48]Zhang, X.; Li, Q.; Tu, Y.; Li, Y.; Coulter, J. Y.; Zheng, L.; Zhao, Y.; Jia, Q.; Peterson, D. E.; Zhu, Y. T. Strong Carbon Nanotube Fibers from Long Carbon Nanotube Arrays. Small 2007, 3, 244-248.
[49]Zheng, L.; Zhang, X.; Li, Q.; Li, Y.; Zhao, Y.; Jia, Q.; Satishkumar, B. C.; Doom, S. K.; Zhu, Y. T. Carbon-Nanotube Cotton for Large-Scale Fibres. Adv. Mater. 2007, 19, 2567-2570.
[50]Li, Q.; Li, Y.; Chikkannanavar, S.; Zhao, Y.; Dangelewicz, A.; Zhang, X.; Zheng, L.; Doom, S. K.; Jia, Q.; Peterson, D. E.; Arendt, P. A.; Zhu, Y. T. Structure-Dependent Electronic Properties of Carbon Nanotube Fibers. Adv. Mater. 2007, 19, 3358-3363.
[51]Zhang, X.; Li, Q.; Holesinger, T. G.; Arendt, P. A.; Huang, J.; Clapp, T. G.; Depaula, R. F.; Liao, X. Z.; Zhao, Y.; Zheng, L.; Peterson, D. E.; Zhu, Y. T. Ultrastrong, Stiff, and Lightweight Carbon Nanotube Fibers, Adv. Mater. 2007, 19, 4198-4201.
[52]Liu, K.; Sun, Y.; Lin, X.; Zhou, R.; Wang, J.; Fan, S.; Jiang, K. Scratch-Resistant, Highly Conductive, and High-Strength Carbon Nanotube-Based Composite Yarns. ACS Nano 2010, 4, 5827-5834.
[53]Coleman, J. N.; Cadek, M.; Blake, R.; Nicolosi, V.; Ryan, K. P.; Belton, C.; Fonseca, A.; Nagy, J. B.; Gun'ko, Y. K.; Blau, W. J. High Performance Nanotube-Reinforced Plastics: Understanding the Mechanism of Strength Increase. Adv. Funct. Mater. 2004, 14, 791-798.
[54]Shim, B. S.; Zhu, J.; Jan, E.; Critchley, K.; Ho, S.; Podsiadlo, P.; Sun, K.; Kotov, N. A. Multiparameter Structural Optimization of Single-Walled Carbon Nanotube Composites: Toward Record Strength, Stiffness, and Toughness. ACS Nano 2009, 3, 1711-1722.
[55]Hou, Y.; Tang, J.; Zhang, H.; Qian, C.; Feng, Y.; Liu, J. Functionalized Few-Walled Carbon Nanotubes for Mechanical Reinforcement of Polymeric Composites. ACS Nano 2009, 3, 1057-1062.
[56]Fang, C.; Zhao, J.; Jia, J.; Zhang, Z.; Zhang, X.; Li, Q. Enhanced carbon nanotube fibers by polyimide. Appl. Phys. Lett. 2010, 97, 181906.
[57]Cheng, Q.; Wang, B.; Zhang, C.; Liang, Z. Functionalized Carbon-Nanotube Sheet/Bismaleimide Nanocomposites: Mechanical and Electrical Performance Beyond Carbon-Fiber Composites. Small 2010, 6, 763-767.
[58]Qian, D.; Dickey, E. C.; Andrews, R.; Rantell, T. Load transfer and deformation mechanisms in carbon nanotube-polystyrene composites. Appl. Phys. Lett. 2000, 76, 2868-2870.
[59]Jia, J.; Zhao, J.; Xu, G; Di, J.; Yong, Z.; Tao, Y.; Fang, C.; Zhang, Z.; Zhang, X.; Zheng, L. et al. A comparison of the mechanical properties of fibers spun from different carbon nanotubes. Carbon 2011, 49, 1333-1339.
[60]Frogley, M. D.; Zhao, Q.; Wagner, H. D. Polarized resonance Raman spectroscopy of single-wall carbon nanotubes within a polymer under strain. Phys. Rev. B 2002, 65, 113413.
[61]Raravikar, N. R.; Schadler, L. S.; Vijayaraghavan, A.; Zhao, Y.; Wei, B.; Ajayan, P. M. Synthesis and Characterization of Thickness-Aligned Carbon Nanotube-Polymer Composite Films. Chem. Mater. 2005, 17, 974-983.
[62]Cheng, Q. F.; Wang, J. P.; Wen, J. J.; Liu, C. H.; Jiang, K. L.; Li, Q. Q.; Fan, S. S. Carbon nanotube/epoxy composites fabricated by resin transfer molding. Carbon 2010, 48, 260-266.
[63]Mamedov, A. A.; Kotov, N. A.; Prato, M.; Guldi, D. M.; Wicksted, J. P.; Hirsch, A. Molecular design of strong single-wall carbon nanotube/polyelectrolyte multilayer composites. Nat. Mater. 2002, 1, 190-194.
[64]Olek, M.; Ostrander, J.; Jurga, S.; Mohwald, H.; Kotov, N.; Kempa, K.; Giersig, M. Layer-by-Layer Assembled Composites from Multiwall Carbon Nanotubes with Different Morphologies. Nano Lett. 2004, 4, 1889-1895.
[65]Inoue, Y.; Kakihata, K.; Hirono, Y.; Horie, T.; Ishida, A.; Mimura, H. One-step grown aligned bulk carbon nanotubes by chloride mediated chemical vapor deposition. Appl. Phys. Lett. 2008, 21, 213113.
[66]Ma, W.; Liu, L.; Zhang, Z.; Yang, R.; Liu, G; Zhang, T.; An, X.; Yi, X.; Ren, Y.; Niu, Z.; Li, J.; Dong, H.; Zhou, W.; Ajayan, P. M.; Xie, S. High-strength composite fibers: Realizing true potential of carbon nanotubes in polymer matrix through continuous reticulate architecture and molecular level couplings. Nano Lett. 2009, 8, 2855-2861.
[67]Chae, H. G.; Kumar, S. Materials science—making strong fibers. Science 2008, 5865, 908-909.
[68] Cheng, Q. F.; Bao, J. W.; Park, J. G; Liang, Z. Y.; Zhang, C.; Wang, B. High mechanical performance composite conductor: Multi-walled carbon nanotube Sheet/Bismaleimide nanocomposites. Adv. Funct. Mater 2009, 20, 3219-3225.
[69]Bradford P.D., Wang X., Zhao H., Maria J., Jia Q., Zhu Y. T. A novel approach to fabricate high volume fraction nanocomposites with long aligned carbon nanotubes. Compos. Sci. Technol. 2010, 13, 1980.
[70]Fisher, F. T.; Bradshaw, R. D.; Brinson, L. C. Fiber waviness in nanotube-reinforced polymer composites-1: Modulus predictions using effective nanotube properties. Compos. Sci. Technol. 2003, 11, 1689-1703.
[71]Bradshaw, R. D.; Fisher, F. T.; Brinson, L. C. Fiber waviness in nanotube-reinforced polymer composites-II: Modeling via numerical approximation of the dilute strain concentration tensor. Compos. Sci. Technol. 2003, 11, 1705-1722.
[72]Anumandla, V.; Gibson, R. F. A comprehensive closed form micromechanics model for estimating the elastic modulus of nanotube-reinforced composites. Composites Part A 2006, 12, 2178-2185.
[73]Hsiao, H. M.; Daniel, I. M. Elastic properties of composites with fiber waviness. Composites Part A 1996, 10, 931-941.
[74]Baji, A.; Mai, Y.; Wong, S.; Abtahi, M.; Du, X. Mechanical behavior of self-assembled carbon nanotube reinforced nylon 6,6 fibers. Compos. Sci. Technol. 2010, 9, 1401-1409.
[75]Liu, T. X.; Phang, I. Y.; Shen, L.; Chow, S. Y.; Zhang, W. D. Morphology and mechanical properties of multiwalled carbon nanotubes reinforced nylon-6 composites. Macromolecules 2004, 19, 7214-7222.
[76]Shen, Z. G.; Zhu, F. M.; Liu, D.; Zeng, X. G; Lin, S. G Preparation of syndiotactic polystyrene/montmorillonite nanocomposites via in situ intercalative polymerization of styrene with monotitanocene catalyst. J Appl Polym Sci 2005, 6, 1412-1417.
[77]Chen, G; Kim, H.; Park, B. H.; Yoon, J. Multi-walled carbon nanotubes reinforced nylon 6 composites. Polymer 2006, 13, 4760-4767.
[78]Cheng, Q.; Wang, B.; Zhang, C.; Liang, Z. Functionalized carbon-nanotube sheet/bismaleimide nanocomposites: Mechanical and electrical performance beyond carbon-fiber composites. Small 2010, 6, 763-767.
[79]Chou, T.; Gao, L.; Thostenson, E. T.; Zhang, Z.; Byun, J. An assessment of the science and technology of carbon nanotube-based fibers and composites. Compos. Sci. Technol. 2010, 1, 1-19.
[80]Cui, S.; Kinloch, I. A.; Young, R. J.; Noe, L.; Monthioux, M. The effect of stress transfer within double-walled carbon nanotubes upon their ability to reinforce composites. Adv Mater 2009, 35, 3591-3595.
[81]King, J. A.; Tucker, K. W.; Vogt, B. D.; Weber, E. H.; Quan, C. L. Electrically and thermally conductive nylon 6,6. Polym. Compos. 1999, 5, 643-654.
[82]Jeong, J.; Lee, H.; Kang, S.; Tan, L.; Baek, J. Nylon 610/functionalized multiwalled carbon nanotube composite prepared from in-situ interfacial polymerization. J. Polym. Sci., Part A: Polym. Chem. 2008, 18, 6041-6050.
[83]Moisala, A.; Li, Q.; Kinloch, I. A.; Windle, A. H. Thermal and electrical conductivity of single- and multi-walled carbon nanotube-epoxy composites. Compos. Sci. Technol. 2006, 10, 1285-1288.
[84]Geng, Y.; Liu, M. Y.; Li, J.; Shi, X. M.; Kim, J. K. Effects of surfactant treatment on mechanical and electrical properties of CNT/epoxy nanocomposites. Composites Part A 2008, 12, 1876-1883.
[85]Fischer, J. E.; Zhou, W.; Vavro, J.; Llaguno, M. C.; Guthy, C.; Haggenmueller, R.; Casavant, M. J.; Walters, D. E.; Smalley, R. E. Magnetically aligned single wall carbon nanotube films: Preferred orientation and anisotropic transport properties. J. Appl. Phys. 2003, 4, 2157-2163.
[86]Pegel, S.; Poetschke, P.; Villmow, T.; Stoyan, D.; Heinrich, G. Spatial statistics of carbon nanotube polymer composites. Polymer 2009, 9, 2123-2132.
[87]Yu M F, Lourie O, Dyer M J, Moloni K, Kelly T F, Ruoff R S. Strength and breaking mechanism of multiwalled carbon nanotubes under tensile load. Science 2000; 287(5453):637-640.
[88]Xie X L, Mai Y W, Zhou X P. Dispersion and alignment of carbon nanotubes in polymer matrix: A review. Materials Science & Engineering R-Reports 2005; 49(4):89-112.
[89] Jia Z J, Wang Z Y, Xu C L, Liang J, Wei B Q, Wu D H, Zhu S W. Study on poly(methyl methacrylate)/carbon nanotube composites. Materials Science and Engineering a-Structural Materials Properties Microstructure and Processing 1999; 271(1-2):395-400.
[90]Moniruzzaman M, Du F M, Romero N, Winey K I. Increased flexural modulus and strength in SWNT/epoxy composites by a new fabrication method. Polymer 2006; 47(1):293-298.
[91]Feng Q, Yang J, Fu S, Mai Y. Synthesis of carbon nanotube/epoxy composite films with a high nanotube loading by a mixed-curing-agent assisted layer-by-layer method and their electrical conductivity. Carbon 2010; 48(7):2057-2062.
[92]Li Q W, Zhang X F, DePaula R F, Zheng L X, Zhao Y H, Stan L, Holesinger T G, Arendt P N, Peterson D E, Zhu Y T. Sustained growth of ultralong carbon nanotube arrays for fiber spinning Advanced Materials 2006; 18(23):3160.
[93]Tran C D, Humphries W, Smith S M, Huynh C, Lucas S. Improving the tensile strength of carbon nanotube spun yarns using a modified spinning process. Carbon 2009; 47(11):2662-2670.
[94]Cheng Q F, Bao J W, Park J G, Liang Z Y, Zhang C, Wang B. High Mechanical Performance Composite Conductor: Multi-Walled Carbon Nanotube Sheet/Bismaleimide Nanocomposites. Advanced Functional Materials 2009; 19(20):3219-3225.
[95]Cheng Q, Wang B, Zhang C, Liang Z. Functionalized carbon-nanotube sheet/bismaleimide nanocomposites: mechanical and electrical performance beyond carbon-fiber composites. Small 2010; 6(6):763-767.
[96]Minot E D, Yaish Y, Sazonova V, Park J Y, Brink M, McEuen P L. Tuning carbon nanotube band gaps with strain. Phys Rev Lett 2003; 90(15):156401.
[97]Gordon D A, Wang S K, Chung D D L. Piezoresistivity in unidirectional continuous carbon fiber polymer-matrix composites: single-lamina composite versus two-lamina composite. Composite Interfaces 2004; 11(1):95-103.
[98] Wang S K, Chung D D L. Electrical behavior of carbon fiber polymer-matrix composites in the through-thickness direction. J Mater Sci 2000; 35(1):91-100.
[99]Pham G T, Park Y, Liang Z, Zhang C, Wang B. Processing and modeling of conductive thermoplastic/carbon nanotube films for strain sensing. Composites Part B-Engineering 2008; 39(1):209-216.
[100] Buldum A, Lu J P. Contact resistance between carbon nanotubes. Physical Review B 2001; 63(16):161403.
[101] Peng X, Wong S S. Functional Covalent Chemistry of Carbon Nanotube Surfaces. Adv Mater 2009; 21(6):625-642.
[102] Yang K, Gu M, Guo Y, Pan X, Mu G. Effects of carbon nanotube functionalization on the mechanical and thermal properties of epoxy composites. Carbon 2009; 47(7):1723-1737.
[103] Khan M U, Gomes V G, Altarawneh I S. Synthesizing polystyrene/carbon nanotube composites by emulsion polymerization with non-covalent and covalent functionalization. Carbon 2010; 48(10):2925-2933.
[104] Ajayan P M, Tour J M. Materials science—Nanotube composites. Nature 2007; 447(7148):1066-1068.
[105] Pan C T, Hocheng H. Evaluation of anisotropic thermal conductivity for unidirectional FRP in laser machining. Composites Part A-Applied Science and Manufacturing 2001; 32(11):1657-1667.
[106] Springer G S, Tsai S W. Thermal conductivities of unidirectional materials. J Comps Mater 1967; 1(2):166-173.

In general, terms such as “communicate” and “in . . . communication with” (for example, a first component “communicates with” or “is in communication with” a second component) are used herein to indicate a structural, functional, mechanical, electrical, thermal, signal, optical, magnetic, electromagnetic, ionic, covalent or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for fabricating a carbon nanotube (CNT) composite, the method comprising:
providing an array of CNTs that are substantially aligned in a single direction;
pulling a CNT ribbon from the array by attaching the CNT ribbon to a rotating mandrel and winding the CNT ribbon on the mandrel as the mandrel rotates; and
applying a polymer solution to the CNT ribbon as the CNT ribbon is pulled from the array and wound on the mandrel to form a CNT composite laminate, wherein the polymer solution comprises a polymer and a solvent.

2. The method of claim 1, wherein applying the polymer solution to the CNT ribbon comprises passing the CNT ribbon through a solution bath including the polymer solution, or spraying the polymer solution on the CNT ribbon.

3. The method of claim 1, further comprising obtaining a desired mass fraction of CNTs within the CNT composite laminate by adjusting a parameter selected from the group consisting of: (1) the concentration of the polymer within the polymer solution; (2) the speed at which the CNT ribbon is pulled; (3) the rate at which the polymer solution is applied to the CNT ribbon; and (4) combinations of two or more of the foregoing.

4. The method of claim 1, wherein the CNT ribbon is pulled from the array until a predetermined value for a parameter associated with the CNT composite laminate is achieved, wherein the parameter is selected from the group consisting of: (1) the width of the CNT composite laminate; (2) the thickness of the CNT composite laminate; (3) the length of the CNT ribbon pulled from the array; and (4) combinations of two or more of the foregoing.

5. The method of claim 1, further comprising causing the mandrel or the CNT array to oscillate along a horizontal axis to obtain a predetermined width associated with the CNT composite laminate.

6. The method of claim 1, further comprising removing the CNT composite laminate from the mandrel, and heating the CNT composite laminate.

7. The method of claim 6, further comprising stretching the CNT composite laminate.

8. The method of claim 1, further comprising stretching the CNT ribbon prior to applying the polymer solution to the CNT ribbon.

9. The method of claim 8, further comprising heating the CNT ribbon prior to applying the polymer solution to the CNT ribbon.

10. A CNT composite made according to the method of claim 1.

11. A CNT composite comprising a polymer integrated with a plurality of long, substantially straight CNTs that are highly aligned in a single direction;
wherein the CNT composite has a Young's modulus ranging from about 14 GPa to about 500 GPa; and
wherein the CNT composite has a tensile strength ranging from about 0.22 GPa to about 10 GPa.

12. The CNT composite of claim 11, wherein the CNT composite has an electrical conductivity ranging from about 140 S/cm to about 5000 S/cm.

13. The CNT composite of claim 11, wherein the CNT composite has a thermal conductivity ranging from about 10 W*m⁻¹K⁻¹ to about 400 W*m⁻¹K⁻¹.

14. The CNT composite of claim 11, wherein the CNT composite has a toughness ranging from about 16 J/g to about 250 J/g.

15. The CNT composite of claim 11, wherein the polymer comprises a thermosetting polymer.

16. The CNT composite of claim 15, wherein the CNT composite has a strain-to-failure ratio ranging from about 1.2% to about 10%.

17. The CNT composite of claim 11, wherein the polymer comprises a thermoplastic polymer.

18. The CNT composite of claim 17, wherein the CNT composite has a strain-to-failure ratio ranging from about 8% to about 13%.

19. An apparatus for fabricating a CNT composite, comprising:
a rotatable mandrel configured for taking up a CNT ribbon from an array of CNTs; and
a spray gun configured for spraying a polymer solution on the CNT ribbon as the CNT ribbon is taken up on the rotating mandrel.

20. The apparatus of claim 19, further comprising at least one tensioning rod configured for stretching the CNT ribbon as the CNT ribbon is pulled into contact with the tensioning rod.
